(19) United States
(12) Patent Application Publication
(10) Pub. No.: US 2026/0370414 A1
(43) Pub. Date: Nov. 19, 2026

(54) RATE SPLITTING FOR A NON-COHERENT JOINT TRANSMISSION

(71) Applicant: QUALCOMM Incorporated, San Diego, CA (US)

(72) Inventors: Mostafa KHOSHNEVISAN, San Diego, CA (US); Chenxi HAO, Beijing (CN); Xiaoxia ZHANG, San Diego, CA (US); Jing SUN, San Diego, CA (US); Ahmed Abdelaziz Ibrahim Abdelaziz ZEWAIL, San Diego, CA (US)

(21) Appl. No.: 19/155,181

(22) PCT Filed: Mar. 17, 2023
(86) PCT No.: PCT/CN2023/082142

§ 371 Date: Aug. 8, 2025

(51) Int. Cl. H04L 5/00

(52) U.S. Cl. CPC H04L 5/0051; H04L 5/0091

(57) ABSTRACT

Methods, systems, and devices for wireless communications are described. A user equipment (UE) may receive first signaling indicating multiple transmission configuration indicator (TCI) states for a non-coherent joint transmission (NCJT) from multiple transmission-reception points (TRPs). The NCJT may include a first portion common to multiple UEs including the UE and a second portion private to the UE. The UE may receive second signaling that schedules the NCJT using multiple sets of DMRS ports and/or layers (e.g., two sets of DMRS ports, three sets of DMRS ports, or four sets of DMRS ports). The TRPs may transmit the NCJT to the UEs in accordance with the DMRS ports and/or layers and using one or more TCI states associated with the sets of DMRS ports and/or layers.

### CROSS REFERENCE

The present Application is a 371 national phase filing of International PCT Application No. PCT/CN2023/082142 by KHOSHNEVISAN et al., entitled “RATE SPLITTING FOR A NON-COHERENT JOINT TRANSMISSION,” filed Mar. 17, 2023, which is assigned to the assignee hereof, and which is expressly incorporated by reference in its entirety herein.

### FIELD OF TECHNOLOGY

The following relates to wireless communications, including rate splitting for a non-coherent joint transmission (NCJT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support rate splitting for a non-coherent joint transmission (NCJT). For example, the described techniques provide for one or more user equipment (UEs) and transmission reception points (TRPs) to communicate signaling using rate splitting when the TRPs are non-coherent. In some examples, a UE may receive signaling indicating multiple transmission configuration indicator (TCI) states for an NCJT from multiple TRPs. The UE may receive additional signaling that schedules the NCJT using multiple sets of demodulation reference signal (DMRS) ports and/or layers, where each set of DMRS port and/or layers may be associated with various TCI states. As an example, the NCJT may include signaling that is scheduled for transmission using a first set of DMRS ports and/or layers that is associated with two TCI states, as well as a second set of DMRS ports and/or layers that is associated with one TCI state of the two TCI states. In some examples, the NCJT may further include the signaling transmitted using a third set of DMRS ports and/or layers that is associated with another TCI state of the two TCI states. The UE may receive the NCJT in accordance with the TCI states. In some cases, the NCJT may include a common portion (e.g., a common stream) and a private portion (e.g., a private stream), and the first set of DMRS ports and/or layers may correspond to the common portion, and the second set of DMRS ports and/or layers (and the third set of DMRS ports and/or layers) may correspond to the private portion.

In some other examples, the NCJT may include signaling that is scheduled for transmission using four sets of DMRS ports. In such cases, a first and third set of DMRS ports and/or layers are associated with a first TCI state and a second and fourth set of DMRS ports and/or layers are associated with a second TCI state. Here, the first and second set of DMRS ports and/or layers may be associated with the common portion of the signaling, and the third and fourth set of DMRS ports and/or layers may be associated with the private portion of the signaling. The UE may receive the NCJT in accordance with the first TCI state.

A method for wireless communication at a UE is described. The method may include receiving first signaling indicating a set of multiple TCI states for an NCJT from a set of multiple TRPs, receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and receiving the NCJT in accordance with the two or more TCI states.

An apparatus for wireless communication at a UE is described. The apparatus may include a processor, memory coupled with the processor, and instructions stored in the memory. The instructions may be executable by the processor to cause the apparatus to receive first signaling indicating a set of multiple TCI states for an NCJT from a set of multiple TRPs, receive second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and receive the NCJT in accordance with the two or more TCI states.

Another apparatus for wireless communication at a UE is described. The apparatus may include means for receiving first signaling indicating a set of multiple TCI states for an NCJT from a set of multiple TRPs, means for receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and means for receiving the NCJT in accordance with the two or more TCI states.

A non-transitory computer-readable medium storing code for wireless communication at a UE is described. The code may include instructions executable by a processor to receive first signaling indicating a set of multiple TCI states for an NCJT from a set of multiple TRPs, receive second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and receive the NCJT in accordance with the two or more TCI states.

Some examples of the method, apparatuses, and non-transitory computer-readable medium described herein may further include operations, features, means, or instructions for transmitting a capability message indicating a capability of the UE to receive the NCJT using the first set of DMRS ports and the second set of DMRS ports, where the NCJT may be scheduled using the first set of DMRS ports and the second set of DMRS ports based on the capability of the UE.

In some examples of the method, apparatuses, and non-transitory computer-readable medium described herein, the capability message indicates a capability of the UE to support one or more codeword mapping schemes for the first set of DMRS ports and the second set of DMRS ports.

In some examples of the method, apparatuses, and non-transitory computer-readable medium described herein, the NCJT includes at least a first portion including first information common to a set of multiple UEs including the UE and a second portion including information specific to the UE and the first set of DMRS ports corresponds to the first portion of the NCJT and the second set of DMRS ports corresponds to the second portion of the NCJT.

Some examples of the method, apparatuses, and non-transitory computer-readable medium described herein may further include operations, features, means, or instructions for determining, in accordance with a mapping between the first set of DMRS ports and a first code division multiplexing (CDM) group and between the second set of DMRS ports and a second CDM group, the first set of DMRS ports based on the first CDM group and the second set of DMRS ports based on the second CDM group different from the first CDM group.

In some examples of the method, apparatuses, and non-transitory computer-readable medium described herein, one or more fields of the second signaling indicate the first set of DMRS ports and the second set of DMRS ports.

Some examples of the method, apparatuses, and non-transitory computer-readable medium described herein may further include operations, features, means, or instructions for determining the first set of DMRS ports and the second set of DMRS ports based on an order of the first set of DMRS ports and the second set of DMRS ports and a respective quantity of DMRS ports in each of the first set of DMRS ports and the second set of DMRS ports, where the second signaling indicates the respective quantity of DMRS ports in each of the first set of DMRS ports and the second set of DMRS ports.

In some examples of the method, apparatuses, and non-transitory computer-readable medium described herein, a single codeword corresponds to the first set of DMRS ports and the second set of DMRS ports and the second signaling indicates one or more parameters associated with the single codeword.

In some examples of the method, apparatuses, and non-transitory computer-readable medium described herein, a first codeword corresponds to the first set of DMRS ports, a second codeword corresponds to the second set of DMRS ports, and the second signaling indicates a first set of parameters associated with the first codeword and a second set of parameters associated with the second codeword.

In some examples of the method, apparatuses, and non-transitory computer-readable medium described herein, the first set of DMRS ports excludes a mapping to a codeword, the codeword corresponds to the second set of DMRS ports, and the second signaling indicates a set of parameters associated with the codeword.

In some examples of the method, apparatuses, and non-transitory computer-readable medium described herein, the second signaling further schedules the NCJT using a third set of DMRS ports associated with a second TCI state of the two or more TCI states.

In some examples of the method, apparatuses, and non-transitory computer-readable medium described herein, the NCJT includes at least a first portion including first information common to a set of multiple UEs including the UE and a second portion including information specific to the UE and the first set of DMRS ports corresponds to the first portion of the NCJT, the second set of DMRS ports corresponds to the second portion of the NCJT, and the third set of DMRS ports correspond to the second portion of the NCJT.

In some examples of the method, apparatuses, and non-transitory computer-readable medium described herein, a first codeword corresponds to the first set of DMRS ports, a second codeword corresponds to the second set of DMRS ports and the third set of DMRS ports, and the second signaling indicates a first set of parameters associated with the first codeword and a second set of parameters associated with the second codeword.

In some examples of the method, apparatuses, and non-transitory computer-readable medium described herein, a first codeword corresponds to the first set of DMRS ports, a second codeword corresponds to the second set of DMRS ports, a third codeword corresponds to the third set of DMRS ports, and the second signaling indicates a first set of parameters associated with the first codeword, a second set of parameters associated with the second codeword, and a third set of parameters associated with the third codeword.

A method for wireless communication at a UE is described. The method may include receiving first signaling indicating a set of multiple TCI states for an NCJT from a set of multiple TRPs, the NCJT including at least a first portion including first information common to a set of multiple UEs including the UE and a second portion including information specific to the UE, receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and receiving the NCJT in accordance with the first TCI state.

An apparatus for wireless communication at a UE is described. The apparatus may include a processor, memory coupled with the processor, and instructions stored in the memory. The instructions may be executable by the processor to cause the apparatus to receive first signaling indicating a set of multiple TCI states for an NCJT from a set of multiple TRPs, the NCJT including at least a first portion including first information common to a set of multiple UEs including the UE and a second portion including information specific to the UE, receive second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and receive the NCJT in accordance with the first TCI state.

Another apparatus for wireless communication at a UE is described. The apparatus may include means for receiving first signaling indicating a set of multiple TCI states for an NCJT from a set of multiple TRPs, the NCJT including at least a first portion including first information common to a set of multiple UEs including the UE and a second portion including information specific to the UE, means for receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and means for receiving the NCJT in accordance with the first TCI state.

A non-transitory computer-readable medium storing code for wireless communication at a UE is described. The code may include instructions executable by a processor to receive first signaling indicating a set of multiple TCI states for an NCJT from a set of multiple TRPs, the NCJT including at least a first portion including first information common to a set of multiple UEs including the UE and a second portion including information specific to the UE, receive second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and receive the NCJT in accordance with the first TCI state.

Some examples of the method, apparatuses, and non-transitory computer-readable medium described herein may further include operations, features, means, or instructions for transmitting a capability message indicating a capability of the UE to receive the NCJT using the first set of DMRS ports, the second set of DMRS ports, the third set of DMRS ports, and the fourth set of DMRS ports, where the NCJT may be scheduled using the first set of DMRS ports, the second set of DMRS ports, the third set of DMRS ports, and the fourth set of DMRS ports based on the capability of the UE.

In some examples of the method, apparatuses, and non-transitory computer-readable medium described herein, the capability message indicates a capability of the UE to support one or more codeword mapping schemes for the first set of DMRS ports, the second set of DMRS ports, the third set of DMRS ports, the fourth set of DMRS ports, or any combination thereof.

Some examples of the method, apparatuses, and non-transitory computer-readable medium described herein may further include operations, features, means, or instructions for determining the first set of DMRS ports, the second set of DMRS ports, the third set of DMRS ports, and the fourth set of DMRS ports based on one or more CDM groups and in accordance with a mapping between the first set of DMRS ports and the one or more CDM groups, the second set of DMRS ports and the one or more CDM groups, the third set of DMRS ports and the one or more CDM groups, and the fourth set of DMRS ports and the one or more CDM groups.

In some examples of the method, apparatuses, and non-transitory computer-readable medium described herein, the first set of DMRS ports and the second set of DMRS ports map to a first CDM group and the third set of DMRS ports and the fourth set of DMRS ports map to a second CDM group based on the mapping of a set of DMRS ports to a respective CDM group corresponding to a respective portion of the NCJT.

In some examples of the method, apparatuses, and non-transitory computer-readable medium described herein, the first set of DMRS ports and the third set of DMRS ports map to a first CDM group and the second set of DMRS ports and the fourth set of DMRS ports map to a second CDM group different from the first CDM group based on the mapping of a set of DMRS ports to a respective CDM group corresponding to a respective TCI state associated with the set of DMRS ports.

In some examples of the method, apparatuses, and non-transitory computer-readable medium described herein, the first set of DMRS ports map to a first CDM group, the second set of DMRS ports map to a second CDM group, the third set of DMRS ports map to a third CDM group, and the fourth set of DMRS ports map to a fourth CDM group based on the mapping of a set of DMRS ports to a respective CDM group being on a per set of DMRS ports basis.

In some examples of the method, apparatuses, and non-transitory computer-readable medium described herein, one or more fields of the second signaling indicate the first set of DMRS ports, the second set of DMRS ports, the third set of DMRS ports, and the fourth set of DMRS ports.

Some examples of the method, apparatuses, and non-transitory computer-readable medium described herein may further include operations, features, means, or instructions for determining the first set of DMRS ports, the second set of DMRS ports, the third set of DMRS ports, and the fourth set of DMRS ports based on the second signaling indicating a respective quantity of DMRS ports in each of the first set of DMRS ports, the second set of DMRS ports, the third set of DMRS ports, and the fourth set of DMRS ports.

In some examples of the method, apparatuses, and non-transitory computer-readable medium described herein, a single codeword corresponds to the first set of DMRS ports, the second set of DMRS ports, the third set of DMRS ports, and the fourth set of DMRS ports and the second signaling indicates one or more parameters associated with the single codeword.

In some examples of the method, apparatuses, and non-transitory computer-readable medium described herein, a first codeword corresponds to the first set of DMRS ports and the second set of DMRS ports, a second codeword corresponding to the third set of DMRS ports and the fourth set of DMRS ports based on a mapping of a set of DMRS ports to a respective codeword corresponding to a respective portion of the NCJT, and the second signaling indicates a first set of parameters associated with the first codeword and a second set of parameters associated with the second codeword.

In some examples of the method, apparatuses, and non-transitory computer-readable medium described herein, a first codeword corresponds to the first set of DMRS ports and the third set of DMRS ports, a second codeword corresponding to the second set of DMRS ports and the fourth set of DMRS ports based on a mapping of a set of DMRS ports to a respective codeword corresponding to a respective TCI state, and the second signaling indicates a first set of parameters associated with the first codeword and a second set of parameters associated with the second codeword.

In some examples of the method, apparatuses, and non-transitory computer-readable medium described herein, a first codeword corresponds to the first set of DMRS ports, a second codeword corresponds to the second set of DMRS ports, a third codeword corresponds to the third set of DMRS ports, a fourth codeword corresponds to the fourth set of DMRS ports, and the second signaling indicates a first set of parameters associated with the first codeword, a second set of parameters associated with the second codeword, a third set of parameters associated with the third codeword, and a fourth set of parameters associated with the fourth codeword.

In some examples of the method, apparatuses, and non-transitory computer-readable medium described herein, the first set of DMRS ports, the second set of DMRS ports, or both exclude a mapping to one or more codewords, the one or more codewords correspond to the third set of DMRS ports and the fourth set of DMRS ports, and the second signaling indicates respective sets of parameters associated with the one or more codewords.

A method for wireless communication at a TRP is described. The method may include transmitting first signaling indicating a set of multiple TCI states for an NCJT from a set of multiple TRPs including the TRP, transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and transmitting the NCJT in accordance with the two or more TCI states.

An apparatus for wireless communication at a TRP is described. The apparatus may include a processor, memory coupled with the processor, and instructions stored in the memory. The instructions may be executable by the processor to cause the apparatus to transmit first signaling indicating a set of multiple TCI states for an NCJT from a set of multiple TRPs including the TRP, transmit second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and transmit the NCJT in accordance with the two or more TCI states.

Another apparatus for wireless communication at a TRP is described. The apparatus may include means for transmitting first signaling indicating a set of multiple TCI states for an NCJT from a set of multiple TRPs including the TRP, means for transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and means for transmitting the NCJT in accordance with the two or more TCI states.

A non-transitory computer-readable medium storing code for wireless communication at a TRP is described. The code may include instructions executable by a processor to transmit first signaling indicating a set of multiple TCI states for an NCJT from a set of multiple TRPs including the TRP, transmit second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states, and transmit the NCJT in accordance with the two or more TCI states.

Some examples of the method, apparatuses, and non-transitory computer-readable medium described herein may further include operations, features, means, or instructions for receiving a capability message indicating a capability of a UE to receive the NCJT using the first set of DMRS ports and the second set of DMRS ports, where the NCJT may be scheduled using the first set of DMRS ports and the second set of DMRS ports based on the capability of the UE.

In some examples of the method, apparatuses, and non-transitory computer-readable medium described herein, the capability message indicates a capability of the UE to support one or more codeword mapping schemes for the first set of DMRS ports and the second set of DMRS ports.

In some examples of the method, apparatuses, and non-transitory computer-readable medium described herein, the NCJT includes at least a first portion including first information common to a set of multiple UEs and a second portion including information specific to a UE of the set of multiple UEs and the first set of DMRS ports corresponds to the first portion of the NCJT and the second set of DMRS ports corresponds to the second portion of the NCJT.

In some examples of the method, apparatuses, and non-transitory computer-readable medium described herein, one or more fields of the second signaling indicate the first set of DMRS ports and the second set of DMRS ports.

In some examples of the method, apparatuses, and non-transitory computer-readable medium described herein, the second signaling indicates a respective quantity of DMRS ports in each of the first set of DMRS ports and the second set of DMRS ports.

Some examples of the method, apparatuses, and non-transitory computer-readable medium described herein may further include operations, features, means, or instructions for mapping the first set of DMRS ports and the second set of DMRS ports to a single codeword, where the second signaling indicates one or more parameters associated with the single codeword.

Some examples of the method, apparatuses, and non-transitory computer-readable medium described herein may further include operations, features, means, or instructions for mapping the first set of DMRS ports to a first codeword and mapping the second set of DMRS ports to a second codeword, where the second signaling indicates a first set of parameters associated with the first codeword and a second set of parameters associated with the second codeword.

Some examples of the method, apparatuses, and non-transitory computer-readable medium described herein may further include operations, features, means, or instructions for mapping the second set of DMRS ports to a codeword, where the second signaling indicates a set of parameters associated with the codeword and refraining from mapping the first set of DMRS ports to the codeword.

In some examples of the method, apparatuses, and non-transitory computer-readable medium described herein, the second signaling further schedules the NCJT using a third set of DMRS ports associated with a second TCI state of the two or more TCI states.

In some examples of the method, apparatuses, and non-transitory computer-readable medium described herein, the NCJT includes at least a first portion including first information common to a set of multiple UEs and a second portion including information specific to a UE of the set of multiple UEs and the first set of DMRS ports corresponds to the first portion of the NCJT, the second set of DMRS ports corresponds to the second portion of the NCJT, and the third set of DMRS ports correspond to the second portion of the NCJT.

Some examples of the method, apparatuses, and non-transitory computer-readable medium described herein may further include operations, features, means, or instructions for mapping the first set of DMRS ports to a first codeword, the second set of DMRS ports to a second codeword, and the third set of DMRS ports to the second codeword, where the second signaling indicates a first set of parameters associated with the first codeword and a second set of parameters associated with the second codeword.

Some examples of the method, apparatuses, and non-transitory computer-readable medium described herein may further include operations, features, means, or instructions for mapping the first set of DMRS ports to a first codeword, the second set of DMRS ports to a second codeword, and the third set of DMRS ports to a third codeword, where the second signaling indicates a first set of parameters associated with the first codeword, a second set of parameters associated with the second codeword, and a third set of parameters associated with the third codeword.

A method for wireless communication at a TRP is described. The method may include transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs, transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and transmitting the NCJT in accordance with the first TCI state and the second TCI state.

An apparatus for wireless communication at a TRP is described. The apparatus may include a processor, memory coupled with the processor, and instructions stored in the memory. The instructions may be executable by the processor to cause the apparatus to transmit first signaling indicating a set of multiple TCI states for an NCJT from a set of multiple TRPs including the TRP, the NCJT including at least a first portion including first information common to a set of multiple UEs and a second portion including information specific to a UE of the set of multiple UEs, transmit second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and transmit the NCJT in accordance with the first TCI state and the second TCI state.

Another apparatus for wireless communication at a TRP is described. The apparatus may include means for transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs, means for transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and means for transmitting the NCJT in accordance with the first TCI state and the second TCI state.

A non-transitory computer-readable medium storing code for wireless communication at a TRP is described. The code may include instructions executable by a processor to transmit first signaling indicating a set of multiple TCI states for an NCJT from a set of multiple TRPs including the TRP, the NCJT including at least a first portion including first information common to a set of multiple UEs and a second portion including information specific to a UE of the set of multiple UEs, transmit second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT, and transmit the NCJT in accordance with the first TCI state and the second TCI state.

Some examples of the method, apparatuses, and non-transitory computer-readable medium described herein may further include operations, features, means, or instructions for receiving a capability message indicating a capability of the UE to receive the NCJT using the first set of DMRS ports, the second set of DMRS ports, the third set of DMRS ports, and the fourth set of DMRS ports, where the NCJT may be scheduled using the first set of DMRS ports, the second set of DMRS ports, the third set of DMRS ports, and the fourth set of DMRS ports based on the capability of the UE.

In some examples of the method, apparatuses, and non-transitory computer-readable medium described herein, the capability message indicates a capability of the UE to support one or more codeword mapping schemes for the first set of DMRS ports, the second set of DMRS ports, the third set of DMRS ports, the fourth set of DMRS ports, or any combination thereof.

In some examples of the method, apparatuses, and non-transitory computer-readable medium described herein, the first set of DMRS ports and the third set of DMRS ports map to a first CDM group and the second set of DMRS ports and the fourth set of DMRS ports map to a second CDM group different from the first CDM group based on the mapping of a set of DMRS ports to a respective CDM group corresponding to a respective TCI state associated with the set of DMRS ports.

In some examples of the method, apparatuses, and non-transitory computer-readable medium described herein, the first set of DMRS ports and the second set of DMRS ports map to a first CDM group and the third set of DMRS ports and the fourth set of DMRS ports map to a second CDM group based on the mapping of a set of DMRS ports to a respective CDM group corresponding to a respective portion of the NCJT.

In some examples of the method, apparatuses, and non-transitory computer-readable medium described herein, the first set of DMRS ports map to a first CDM group, the second set of DMRS ports map to a second CDM group, the third set of DMRS ports map to a third CDM group, and the fourth set of DMRS ports map to a fourth CDM group based on the mapping of a set of DMRS ports to a respective CDM group being on a per set of DMRS ports basis.

In some examples of the method, apparatuses, and non-transitory computer-readable medium described herein, one or more fields of the second signaling indicate the first set of DMRS ports, the second set of DMRS ports, the third set of DMRS ports, and the fourth set of DMRS ports.

In some examples of the method, apparatuses, and non-transitory computer-readable medium described herein, the second signaling indicates a respective quantity of DMRS ports in each of the first set of DMRS ports, the second set of DMRS ports, the third set of DMRS ports, and the fourth set of DMRS ports.

Some examples of the method, apparatuses, and non-transitory computer-readable medium described herein may further include operations, features, means, or instructions for mapping the first set of DMRS ports, the second set of DMRS ports, the third set of DMRS ports, and the fourth set of DMRS ports to a single codeword, where the second signaling indicates one or more parameters associated with the single codeword.

Some examples of the method, apparatuses, and non-transitory computer-readable medium described herein may further include operations, features, means, or instructions for mapping the first set of DMRS ports and the second set of DMRS ports to a first codeword and mapping the third set of DMRS ports and the fourth set of DMRS ports to a second codeword based on a set of DMRS ports mapping to a respective codeword corresponding to a respective portion of the NCJT, where the second signaling indicates a first set of parameters associated with the first codeword and a second set of parameters associated with the second codeword.

Some examples of the method, apparatuses, and non-transitory computer-readable medium described herein may further include operations, features, means, or instructions for mapping the first set of DMRS ports and the third set of DMRS ports to a first codeword and mapping the second set of DMRS ports and the fourth set of DMRS ports to a second codeword based on a set of DMRS ports mapping to a respective codeword corresponding to a respective TCI state, where the second signaling indicates a first set of parameters associated with the first codeword and a second set of parameters associated with the second codeword.

Some examples of the method, apparatuses, and non-transitory computer-readable medium described herein may further include operations, features, means, or instructions for mapping the first set of DMRS ports to a first codeword, mapping the second set of DMRS ports to a second codeword, mapping the third set of DMRS ports to a third codeword, and mapping the fourth set of DMRS ports to a fourth codeword, where the second signaling indicates a first set of parameters associated with the first codeword, a second set of parameters associated with the second codeword, a third set of parameters associated with the third codeword, and a fourth set of parameters associated with the fourth codeword.

Some examples of the method, apparatuses, and non-transitory computer-readable medium described herein may further include operations, features, means, or instructions for mapping the third set of DMRS ports and the fourth set of DMRS ports to one or more codewords, where the second signaling indicates respective sets of parameters associated with the one or more codewords and refraining from mapping the first set of DMRS ports, the second set of DMRS ports, or both to the one or more codewords.

### BRIEF DESCRIPTION OF THE DRAWINGS

FIG. 1 illustrates an example of a wireless communications system that supports rate splitting for a non-coherent joint transmission (NCJT) in accordance with one or more aspects of the present disclosure.

FIG. 2 illustrates an example of a rate splitting diagram that supports rate splitting for an NCJT in accordance with one or more aspects of the present disclosure.

FIG. 3 illustrates an example of a wireless communications system that supports rate splitting for an NCJT in accordance with one or more aspects of the present disclosure.

FIGS. 4A, 4B, and 4C illustrate examples of wireless communications systems that support rate splitting for an NCJT in accordance with one or more aspects of the present disclosure.

FIGS. 5 and 6 illustrate examples of process flows that support rate splitting for an NCJT in accordance with one or more aspects of the present disclosure.

FIGS. 7 and 8 illustrate block diagrams of devices that support rate splitting for an NCJT in accordance with one or more aspects of the present disclosure.

FIG. 9 illustrates a block diagram of a communications manager that supports rate splitting for an NCJT in accordance with one or more aspects of the present disclosure.

FIG. 10 illustrates a diagram of a system including a device that supports rate splitting for an NCJT in accordance with one or more aspects of the present disclosure.

FIGS. 11 and 12 illustrate block diagrams of devices that support rate splitting for an NCJT in accordance with one or more aspects of the present disclosure.

FIG. 13 illustrates a block diagram of a communications manager that supports rate splitting for an NCJT in accordance with one or more aspects of the present disclosure.

FIG. 14 illustrates a diagram of a system including a device that supports rate splitting for an NCJT in accordance with one or more aspects of the present disclosure.

FIGS. 15 through 22 illustrate flowcharts showing methods that support rate splitting for an NCJT in accordance with one or more aspects of the present disclosure.

### DETAILED DESCRIPTION

In some wireless communications systems, one or more network entities may communicate with multiple user equipment (UEs) over a wireless network, such as via one or more transmission-reception points (TRPs). For example, the TRPs may transmit and receive signals to and from the UEs and the network entity, where the TRPs may be phase coherent if there is a constant phase difference between the signals from each TRP (e.g., a relative phase across the signals does not changes with respect to time). In other examples, the TRPs may not be phase coherent if there is not a constant phase difference between the signals from each TRP. If the TRPs are phase coherent, the TRPs may employ rate splitting for multiple user (MU) multiple input multiple output (MIMO) transmissions, via which the TRPs and/or a network entity may partition one or more downlink messages to UEs into a common portion and a private portion. The private portion of each message may be specific to a respective UE and the common portion of each message may be concatenated into a common message, or a common stream, that is shared across the one or more UEs.

If the TRPs are not phase coherent, however, the TRPs may be unable to perform rate splitting due to the mismatch of the phases for the private portion and common portion of the downlink messages. Instead, the TRPs may implement a spatial division multiplexing (SDM) scheme for a non-coherent joint transmission (NCJT), where a downlink channel carrying the downlink message includes respective sets of layers associated with one or more common transmission configuration indicator (TCI) states for each TRP. However, using an SDM scheme when the TRPs are not phase coherent may increase interference at the UEs, which may cause latency and inefficient resource utilization due to retransmission of unsuccessful transmissions.

In some examples, one or more TRPs may transmit signaling indicating TCI states for one or more UEs to use for an NCJT from multiple TRPs. The one or more TRPs may schedule the NCJT using multiple sets of demodulation reference signal (DMRS) ports and/or layers. For example, the sets of DMRS ports may include a first set of DMRS ports and/or layers and a second set of DMRS ports and/or layers. In some cases, the first set of DMRS ports and/or layers may be associated with two or more TCI states and the second set of DMRS ports and/or layers may be associated with one TCI state of the two or more TCI states. In some cases, a third set of DMRS ports and/or layers may be included in the NCJT, and the third set of DMRS ports and/or layers may be associated with a third TCI state of the two or more TCI states. The TRPs may transmit the NCJT to UEs based on the respective TCI states. In some aspects, rate splitting may be used for the NCJT, and the first set of DMRS ports and/or layers may be associated with a common portion of the signaling, whereas the second (and third) set of DMRS ports and/or layers may be associated with a private portion of the signaling. In such cases, the use of the two or more TCI states for the first set of DMRS ports and/or layers may be associated with the common portion being transmitted in accordance with a single-frequency network (SFN) transmission scheme (e.g., the common stream is sent using the same resources (e.g., frequency resources) in a synchronized manner from the TRPs), whereas the respective TCI states for the second and third sets of DMRS ports and/or layers of the NCJT may be sent in accordance with a spatial-division multiplexing (SDM) transmission scheme (e.g., different data streams may be transmitted using precoding weights such that the data streams may be recovered independently).

In some other examples, the sets of DMRS ports and/or layers used for the NCJT signaling may include four sets of DMRS ports and/or layers, such as for an NCJT with rate splitting (e.g., an NCJT with a common portion and one or more private portions). In such cases, a first and third set of DMRS ports and/or layers may each be associated with a first TCI state, and a second and fourth set of DMRS ports and/or layers may each be associated with a second TCI state. Here, the first and second sets of DMRS ports and/or layers correspond to the common portion of the NCJT, and the third and fourth sets of DMRS ports and/or layers correspond to respective private portions of the NCJT. The TRPs may transmit the common portion of the NCJT transmission to multiple UEs (e.g., two UEs) using both TCI states, and transmit the respective private portions of the NCJT transmission to the multiple UEs using respective TCI states for each UE. Such techniques may be associated with the transmission of both the common and private portions of the NCJT in accordance with the SDM transmission scheme. In some examples, a UE may indicate (e.g., via capability signaling) whether the UE supports the NCJT schemes described herein, and the NCJT may be performed by the network entity in accordance with the capability of the UE.

Aspects of the disclosure are initially described in the context of wireless communications systems. Aspects of the disclosure are additionally described in the context of rate splitting diagrams and process flows. Aspects of the disclosure are further illustrated by and described with reference to apparatus diagrams, system diagrams, and flowcharts that relate to rate splitting for an NCJT.

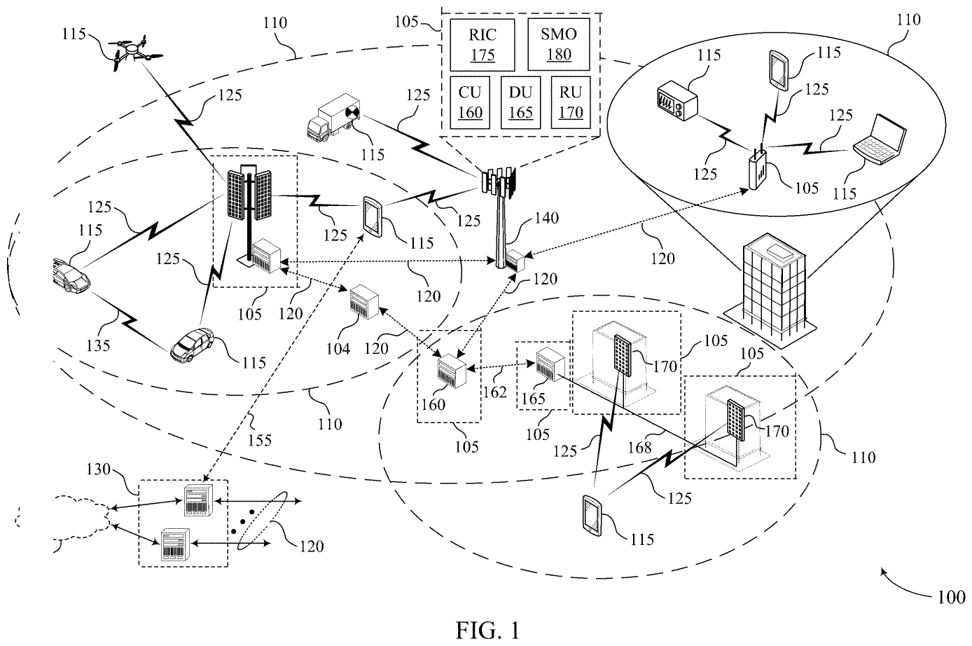

FIG. 1 illustrates an example of a wireless communications system 100 that supports rate splitting for an NCJT in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support rate splitting for an NCJT as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and MU-MIMO, for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large quantity of beams to identify a beam (e.g., the beam having a highest signal quality)). In addition, QCL relationships may exist for both uplink and downlink transmissions and, in some cases, a QCL relationship may also be referred to as spatial relationship information.

In some examples, TCI states may include one or more parameters associated with a QCL relationship between transmitted signals. For example, each TCI state includes parameters for configuring a QCL relationship between one or two downlink reference signals and the DMRS ports of PDSCH, the DMRS port of PDCCH or the CSI-RS port(s) of a CSI-RS resource. The QCL relationship is configured by a first higher layer parameter for the first downlink reference signal, and by a second higher layer parameter for the second downlink reference signal (if configured). That is, a network entity 105 may configure a QCL relationship that provides a mapping between a reference signal and antenna ports of another signal, and the TCI state may be indicated to the UE 115 by the network entity 105. In some cases, a set of TCI states (e.g., a list of TCI states) may be indicated to a UE 115 via RRC signaling, where some quantity of TCI states may be configured via RRC and one or more TCI states may be indicated (e.g., activated) via a medium access control (MAC)-control element (MAC-CE), and further indicated via DCI (e.g., within a CORESET). The QCL relationship associated with the TCI state (and further established through higher-layer parameters) may provide the UE 115 with the QCL relationship for respective antenna ports and reference signals transmitted by the network entity 105.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a network entity 105 may communicate with multiple UEs 115 over a wireless network, such as via one or more TRPs. For example, the TRPs may transmit or receive signals to and from the UEs 115 and the network entity 105, where the TRPs may be phase coherent if there is a constant phase difference between the signals from each TRP (e.g., a relative phase across the signals does not changes with respect to time) or the TRPs may not be phase coherent if there is not a constant phase difference between the signals from each TRP. If the TRPs are phase coherent, the TRPs may employ rate splitting for MU-MIMO transmissions, in which the TRPs and/or network entity 105 may partition one or more downlink messages to UEs 115 into a common portion and a private portion. The private portion of each message may be specific to a respective UE 115 and the common portion of each message may be concatenated into a common message, or a common stream, that is shared across the one or more UEs 115. If the TRPs are not phase coherent, the TRPs may be unable to perform rate splitting due to the mismatch of the phases for the private portion and common portion of the downlink messages. Instead, the TRPs may implement an SDM scheme for an NCJT, where a downlink channel carrying the downlink message includes respective sets of layers with one or more common TCI states for each TRP. However, using an SDM scheme when the TRPs are not phase coherent may increase interference at the UEs 115, which may cause latency and inefficient resource utilization due to retransmission of unsuccessful transmissions.

In some examples, one or more TRPs may transmit signaling indicating TCI states for one or more UEs 115 to use for an NCJT from multiple TRPs. The one or more TRPs may schedule the NCJT using multiple sets of DMRS ports and/or layers. For example, the sets of DMRS ports and/or layers may include a first set of DMRS ports and/or layers and a second set of DMRS ports and/or layers. In some cases, the first set of DMRS ports and/or layers may be associated with two or more TCI states and the second set of DMRS ports and/or layers may be associated with one TCI state of the two or more TCI states. In some examples, a third set of DMRS ports and/or layers may be included in the NCJT, and the third set of DMRS ports and/or layers may be associated with a third TCI state of the two or more TCI states. The TRPs may transmit the NCJT to UEs using the respective TCI states.

In some other examples, the sets of DMRS ports and/or layers may include four sets of DMRS ports and/or layers, such as for an NCJT with rate splitting (e.g., an NCJT with a common portion and one or more private portions). In such cases, a first and third set of DMRS ports and/or layers may each be associated with a first TCI state and a second and fourth set of DMRS ports and/or layers may each be associated with a second TCI state, such that the first and second set of DMRS ports and/or layers corresponds to the common portion of the NCJT and the third and fourth set of DMRS ports and/or layers corresponds to respective private portions of the NCJT. The TRPs may transmit the common portion of the NCJT transmission to multiple UEs 115 (e.g., two UEs 115) using both TCI states, and transmit the respective private portions of the NCJT transmission to the multiple UEs 115 using respective TCI states for each UE 115.

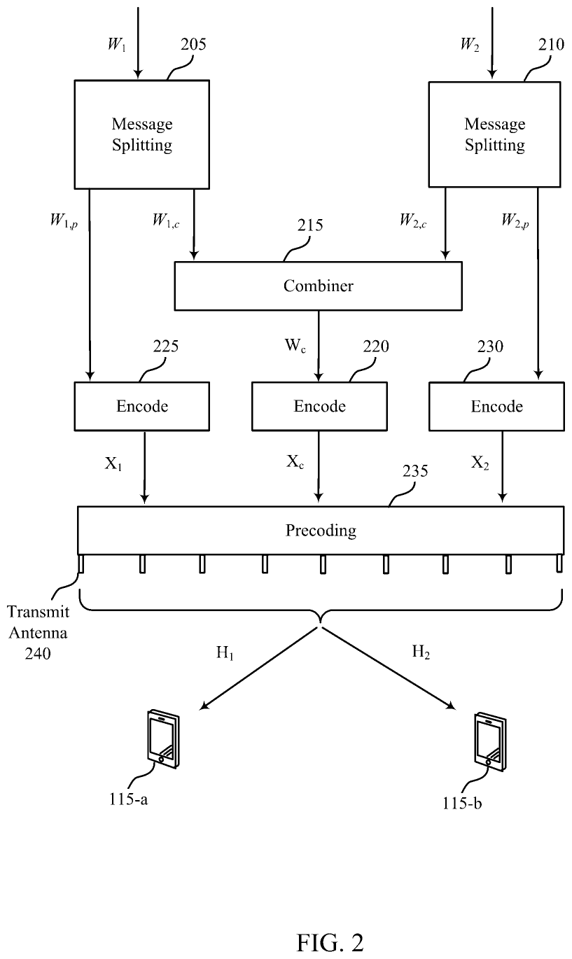

FIG. 2 illustrates an example of a rate splitting diagram 200 that supports rate splitting for an NCJT in accordance with one or more aspects of the present disclosure. The rate splitting diagram 200 may be implemented by aspects of the wireless communications system 100. For example, the rate splitting diagram 200 may show techniques for transmitting signaling from one or more network entities (e.g., via one or more TRPs) to one or more UEs (e.g., UE 115-a, UE 115-b), where the network entities and the UEs may be examples of the corresponding devices described with reference to FIG. 1. The rate splitting diagram 200 may illustrate an example of rate splitting techniques in which messages for one or more users may be split into a common and private portion.

In some cases, one or more wireless devices (e.g., a UE, a TRP, a network entity, or any combination thereof) may communicate using rate splitting techniques. For example, in MU-MIMO a network node, which may be a TRP or a network entity, may communicate with multiple UEs, such as UE 115-a and UE 115-b. The network node may split messages to the UEs into a common message to be decoded by the multiple UEs and private messages unique to each UE (e.g., a first private message unique to the UE 115-a and a second private message unique to UE 115-b). In some examples, the network node may use the rate splitting techniques for a broadcast channel to achieve a relatively high degree of freedom for transmissions, a relatively high capacity for transmissions, or both. In some cases, the common part of individual messages of two or more UEs may be concatenated, or combined, into a common message, W_{c}, encoded and modulated to obtain, X_{c}, which may be referred to as a common stream and may have one or more layers.

For example, a network node may perform message splitting at 205 and 210, respectively, for a UE 115-a and a UE 115-b, where respective messages (e.g., W₁, W₂) are split into multiple portions. Based on the message splitting, at 215, a common portion of a message for the UE 115-a, W_{1,c}, may be combined with a common portion of a message for the UE 115-b, W_{2,c}, to obtain a common message, W_{c}. In some cases, the network node may modulate and encode the common message at 220 to generate a common stream, X_{c}, and the network node may further encode and modulate a private portion of the message for the UE 115-a, W_{1,p} at 225, as well as a private portion of the message for the UE 115-b, W_{2,p}, at 230. That is, the network node may encode and modulate the private part of individual messages from the UE 115-a and the UE 115-b (e.g., W_{1,p} and W_{2,p}) separately to obtain respective private streams (e.g., X₁ and X₂) for the corresponding UEs. In some examples, the encoding at 220, 225, and 230, may include modulation and mapping to one or more layers in addition to the encoding.

After the encoding and modulation, at 235, the network node may precode the common stream X_{c} using a precoder, P_{c}, where the network node may determine P_{c} based on preconfigured or otherwise defined values. Likewise, the private streams X₁ and X₂ may be precoded according to different precoders, such as P₁ and P₂, respectively.

The network node may transmit the precoded common stream X_{c}, the private stream X₁, and the private stream X₂ together using one or more transmit antennas 240 across one or more TRPs. Here, the combined streams may be represented by X=P_{c}X_{c}+P₁X₁+P₂X₂. In some aspects, one or more TRPs (e.g., multiple TRPs in a coordinated multipoint (COMP) scenario), a network entity, or both may transmit the precoded common stream using at least one transmit antenna 240. Additionally, the network node may transmit the private streams using different transmit antennas 240 than the common stream. The network node may transmit the precoded transmission over a channel (e.g., represented by H₁) to the UE 115-a, which may include the common stream X_{c}, the private stream X₁, or both. For instance, the signal received by the UE 115-a may be represented by Y₁=H₁P_{c}X_{c}+H₁P₁X₁+H₁P₂X₂+N₁, where N₁ may represent any interference or noise that impact the transmission via the channel H₁. In some aspects, the signal Y₁ receive by UE 115-a may include some portion of the private stream associated with the UE 115-b (e.g., P₂X₂) that is simultaneously transmitted to the UE 115-b. Similarly, the network node may transmit the precoded transmission over another channel (e.g., represented by H₂) to the UE 115-b, which may include the common stream X_{c}, the private stream X₂, or both. Accordingly, the signal received by the UE 115-b may be represented by Y₂=H₂P_{c}X_{c}+H₂P₂X₂+H₂P₁X₁+N₂, where N₂ may represent interference or noise associated with the transmission via the channel H₂.

At the receiver side, each UE may decode the received signal, where the common message may be decoded prior to the private message. The common message may serve various purposes to the receiver, as the common message may both aid in decoding of the private message and the common message may also carry some amount of data intended for a particular UE. As an example, the UE 115-a may perform channel estimation for the common stream (e.g., X_{c}) and channel estimation for the private stream (e.g., X₁). Using the channel estimation for the common stream, the UE 115-a may decode the common message W_{c}. In some aspects, such decoding may include demodulation and demapping (e.g., in addition to decoding). Some portion of the common message, W_{c}, may include a portion or component of an individual (e.g., user-specific) message for each UE, W_{1,c} and W_{2,c}, (e.g., embedded in the common message, W_{c}), such as data intended for the individual UEs. Such portions may be used by each UE to obtain the original message for each UE (e.g., W_{1,c} and the private message W_{1,p} may be combined to recover the original message W₁ for the UE 115-a).

In some cases, the UEs may decode the common message to aid with successive interference cancelation (SIC) to decode private messages for each UE. For example, the SIC may involve UE 115-a estimating an effective channel corresponding to a common stream, H₁P_{c}, decoding the common message, W_{c}, and re-encoding the common stream, X_{c}. The UE 115-a may multiply the common stream, X_{c}, by the estimated effective channel and may subtract the result from a received signal, Y₁, to cancel the interference, which may provide a result, Y_{1,p}. That is, a UE (e.g., the UE 115-a) may perform SIC to obtain a version of the signal according to Equation 1:

Y_{1,p}=Y₁−H₁P_{c}X_{c}=H₁P₁X₁+H₁P₂X₂+N₁, (1)

where N₁ is an interference value. Here, Equation 1 may assume some channel estimation efficiency (e.g., assume perfect channel estimation) and successful decoding of the common message. The UE (e.g., the UE 115-a) may then decode the private message, W₁, using Y_{1,p}. For instance, the UE 115-a may use the channel estimation for the common stream to reconstruct the common stream, then subtract the received signal (e.g., Y₁-H₁P_{c}X_{c}) to obtain Y_{1,p}. To obtain W_{1,p}, the UE 115-a may decode (e.g., decode, demodulate, and demap) the private message using the channel estimation from the private stream and Y_{1,p}. As a result, W_{1,p} and W_{1,c} may form the original message, W₁, for the UE 115-a.

In some other examples, the UE 115-a may perform a joint demodulation of the private stream and the common stream, and the UE 115-a may separately decode the private codeword and the common codeword. Performing the SIC may provide for a relatively accurate channel estimation for the common stream, which may improve reliability of the rate-splitting techniques (e.g., due to relatively fewer decoding and reception errors of the common stream). That is, the network node, the UE 115-a, the UE 115-b, or any combination thereof may benefit from a clean channel estimation, resulting in an increase in the chance of decoding the common message successfully as well as the SIC.

In some cases, the common message may include part of the individual message from a subset of co-scheduled UEs. For example, if there are two co-scheduled UEs (e.g., a UE 115-a and a UE 115-b), a message for the UE 115-a may not be split, while a message for the UE 115-b is split (or vice versa). As an example, when the message for the UE 115-a is not split at 205, the message W₁ may be encoded at 225 (e.g., W_{1,p}=W₁ in this example), precoded using a precoder, and transmitted to the UE 115-a (e.g., along with common and private streams associated with the UE 115-b). Further, the common message We may include the common portion of W₂ for the UE 115-b (e.g., W_{c}=W_{2,c} in this example).

As a result, the UE 115-b may decode the common message (e.g., irrespective of whether the UE 115-b performs successive interference cancelation or not), as the common message includes the information intended for the UE 115-b. The UE 115-b may determine one or more DMRS ports of the common stream (e.g., for channel estimation) and a modulation order, as well as HARQ related information (e.g., transport block size, coding rate, new data indicator (NDI), redundancy version (RV), or any combination thereof). The UE 115-a, however, may not decode the common message (e.g., refrain from decoding the common message), or the UE 115-a may optionally decode the common message to perform SIC, for example, to increase the chance of decoding the private, or individual, message. If the UE 115-a does not perform SIC, the UE 115-a may still perform joint demodulation or soft interference cancelation. For this, the UE 115-a may determine the DMRS ports of the common stream to perform channel estimation for the layers of the common stream, as well as a modulation order of the common stream or a common codeword to perform demodulation. In some cases, the UE 115-a may not decode the common message, so may not determine the HARQ related information.

In some examples, one or more UEs may communicate with multiple TRPs in a multi-TRP system. For example, the multiple TRPs may communicate with the UEs based on SDM techniques, in which the TRPs and UEs may perform the communication over independent channels separated in space (e.g., in separate streams through spatially separated antennas). In a multi-TRP system with a single downlink control information (DCI) message, a downlink shared channel may indicate separate TCI states for each TRP, where a TCI state is used to establish a QCL relationship between a target reference signal and a source reference signal. The reference signals may be DMRSs, a sounding reference signals (SRSs), or any other type of reference signals. For example, the one or more UEs and multiple TRPs may exchange reference signals as part of a channel estimation procedure. As such, a UE or TRP receiving the reference signal may use the reference signal to measure or otherwise identify a channel quality or any other metrics associated with the channel between the UE and the multiple TRPs. There may be a TCI state for each set of layers, or set of DMRS ports (e.g., port configured for transmitting or receiving a reference signal), in the SDM scheme. Each set of DMRS ports may map to a same codeword.

In some other examples, the multiple TRPs may communicate with the UEs based on SFN techniques, in which downlink frequency bands or channels are shared across TRPs. For the SFN techniques, each set of layers, or set of DMRS ports, is associated with multiple (e.g., two) TCI states. In some cases, the TRPs may transmit data using the same coded bits with a same scrambling sequence on each set of layers. Similarly, the TRPs may transmit a reference signal (e.g., DMRS) using each set of DMRS ports. In some examples, the network may transmit control signaling indicating the TCI states and a TCI codepoint for the SDM techniques and the SFN techniques, such as using a DCI message that schedules a downlink shared channel transmission (e.g., a physical downlink shared channel (PDSCH) transmission). Additional control signaling (e.g., a MAC-CE) may activate the TCI states and may map one or more TCI states to the TCI codepoint. If the network indicates that the TCI codepoint is mapped to multiple TCI states, then the TRPs and UEs are configured to transmit and receive a downlink shared channel with multiple TCI states according to the SDM or SFN schemes.

The TRPs in the multi-TRP system may be phase coherent if there is a constant phase difference between the signals from each TRP (e.g., a relative phase across the signals does not changes with respect to time). Alternatively, the TRPs may not be phase coherent if there is not a constant phase difference between the signals from each TRP. If the TRPs in the multi-TRP system are phase coherent, then the TRPs may use MU-MIMO techniques (e.g., zero forcing (ZF) precoding) or rate splitting across transmit antennas of the multiple TRPs. In some cases, a UE may not be aware of the multiple TRPs (e.g., the TRPs may be transparent to the UE), such as if a downlink shared channel for a UE has a single TCI state defined by a downlink reference signal transmitted from the multiple TRPs. In some other cases, the UE may be aware of the multiple TRPs (e.g., the TRPs may not be transparent to the UE), such as if a downlink shared channel for the UE has multiple TCI states defined by downlink reference signals transmitted from respective TRPs.

If the TRPs are not phase coherent, the TRPs may be unable to perform rate splitting due to the mismatch of the phases for the private portion and common portion of the downlink messages. Instead, the TRPs may implement the SDM scheme for an NCJT. However, using an SDM scheme when the TRPs are not phase coherent may increase interference at the UEs, which may cause latency and inefficient resource utilization due to retransmission of unsuccessful transmissions. As such, improved techniques may be desirable to enable rate splitting with NCJT techniques.

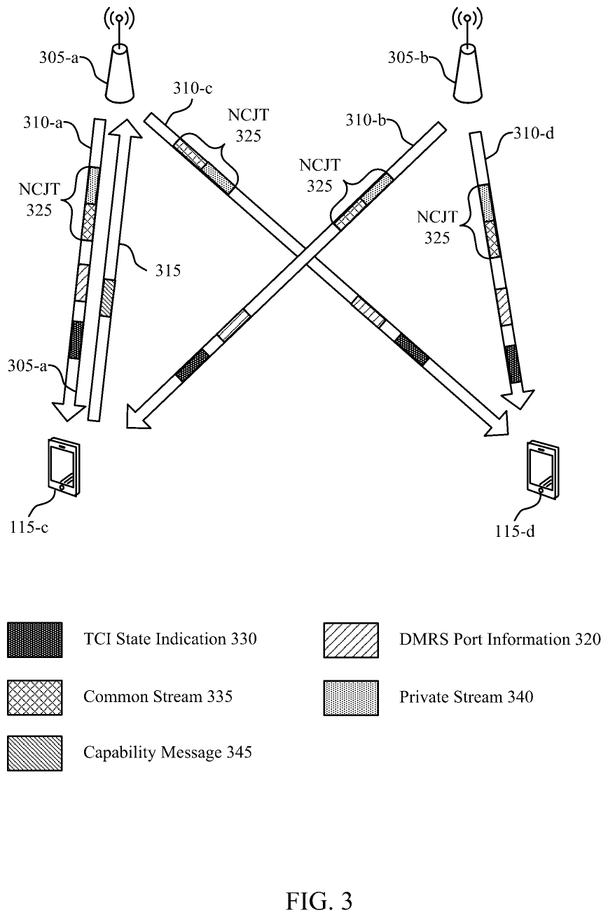

As described herein, a network entity may configure the multiple TRPs and UEs to communicate using sets of DMRS ports and/or layers that are associated with various TCI states, which may provide for the TRPs and UEs to perform rate splitting for an NCJT as described in further detail with respect to FIG. 3. As an example, one or more TRPs may transmit signaling indicating TCI states for the UE 115-a and/or UE 115-b to use for an NCJT from multiple TRPs. The one or more TRPs may schedule (e.g., via DCI) the NCJT using multiple sets of DMRS ports and/or layers. For example, the NCJT may be sent using a first set of DMRS ports and/or layers and a second set of DMRS ports and/or layers. In some cases, the first set of DMRS ports and/or layers may be associated with multiple (e.g., two) TCI states and the second set of DMRS ports and/or layers may be associated with one TCI state of the multiple (e.g., two) TCI states. In some cases, a third set of DMRS ports and/or layers may be included in the NCJT, where the third set of DMRS ports and/or layers may be associated with a third TCI state of the multiple TCI states (e.g., the other TCI state of the two TCI states). The TRPs may transmit the NCJT to the UE 115-a and the UE 115-b based on the respective TCI states. In some aspects, rate splitting may be used for the NCJT, and the first set of DMRS ports and/or layers may be associated with a common portion (e.g., common stream X_{c}) of the signaling, whereas the second (and third) set of DMRS ports and/or layers may be associated with a private portion (e.g., private streams X₁, X₂) of the signaling. In such cases, the use of the two or more TCI states for the first set of DMRS ports and/or layers may enable the common portion to be transmitted in accordance with the SFN transmission scheme, whereas the respective TCI states for the second and third sets of DMRS ports and/or layers of the NCJT may be sent in accordance with a SDM transmission scheme. In some cases, a UE may indicate a capability to support the sets of DMRS ports and/or layers that are respectively associated with one or multiple TCI states for an NCJT.

In some other examples, the sets of DMRS ports and/or layers used for the NCJT signaling may include four sets of DMRS ports and/or layers, such as for an NCJT with rate splitting (e.g., an NCJT with a common portion and one or more private portions). In such cases, a first and third set of DMRS ports and/or layers may each be associated with a first TCI state, and a second and fourth set of DMRS ports and/or layers may each be associated with a second TCI state. Here, the first and second sets of DMRS ports and/or layers correspond to the common portion (e.g., common stream X_{c}) of the NCJT, and the third and fourth sets of DMRS ports and/or layers correspond to respective private portions (e.g., private streams X₁, X₂) of the NCJT. The TRPs may transmit the common portion of the NCJT transmission to multiple UEs (e.g., two UEs) using both TCI states, and transmit the respective private portions of the NCJT transmission to the multiple UEs using respective TCI states for each UE. In some cases, a UE may indicate a capability to support the sets of DMRS ports and/or layers that are respectively associated with the first and second TCI states for the NCJT. Such techniques may enable the transmission of both the common and private portions of the NCJT in accordance with the SDM transmission scheme. The techniques described herein may enable NCJT from multiple TRPs (e.g., with rate splitting, without rate splitting) that results in transmissions with increased reliability, increased data rates, and improved spectral efficiency, among other benefits.

FIG. 3 illustrates an example of a wireless communications system 300 that supports rate splitting for an NCJT in accordance with one or more aspects of the present disclosure. In some examples, the wireless communications system 300 may implement, or be implemented by, aspects of the wireless communications system 100 and the rate splitting diagram 200. The wireless communications system 300 may include a TRP 305-a, a TRP 305-b, a UE 115-c, and a UE 115-d, which may represent examples of the TRPs and the UEs 115 described with reference to FIGS. 1 and 2.

In some examples, the TRP 305-a may transmit control information, data, or both to the UE 115-c and the UE 115-d using a downlink communication link 310-a and a downlink communication link 310-b, respectively. Similarly, the TRP 305-b may transmit control information, data, or both to the UE 115-c and the UE 115-d using a downlink communication link 310-c and a downlink communication link 310-d, respectively. In some cases, a UE may transmit control information, data, or both to one or more TRPs using an uplink communication link 315. For example, the UE 115-c may transmit control information, data, or both to the TRP 305-a using an uplink communication link 315. In some cases, a TRP 305-a and/or a TRP 305-b may indicate DMRS port information 320 for an NCJT 325 from the TRPs to the UE 115-c and the UE 115-d in a MU-MIMO wireless communications system.

In some examples, one or more UEs (e.g., a UE 115-c and a UE 115-d) in communication with multiple TRPs (e.g., the TRP 305-a and the TRP 305-b) may receive signaling indicating multiple TCI states for an NCJT 325 from the TRPs, which may be referred to as a TCI state indication 330. The TRP 305-a may transmit the TCI state indication 330 to the UE 115-c, the UE 115-d, or both via the downlink communication link 310-a and the downlink communication link 310-c, respectively. Additionally, or alternatively, the TRP 305-b may transmit the TCI state indication 330 to the UE 115-c, the UE 115-d, or both via the downlink communication link 310-b and the downlink communication link 310-d, respectively. In some cases, both the TRP 305-a and the TRP 305-b may transmit the signaling to the UE 115-c and the UE 115-d. In some other cases, a single TRP or a network entity may transmit the signaling to the UE 115-c and the UE 115-d. The signaling may be RRC signaling or a MAC-CE.

After transmitting the TCI state indication 330, one or more TRPs, or a network entity, may transmit additional signaling (e.g., a DCI message) that schedules the NCJT 325 and further indicates which TCI states of the multiple TCI states are associated with a downlink transmission (e.g., a TCI codepoint of a DCI field may be mapped to one or more TCI states). The additional signaling may indicate DMRS ports to be used for the NCJT. In some aspects, DMRS ports may be associated with or correspond to layers (e.g., data layers) for a transmission. For example, the TRP 305-a, the TRP 305-b, or a network entity may transmit the DMRS port information 320 to the UE 115-c and the UE 115-d.

In some examples, the DMRS port information 320 may indicate a first set of DMRS ports and/or layers associated with multiple TCI states (e.g., associated with two TCI states) and a second set of DMRS ports associated with one TCI state (e.g., one of the two TCI states). In such cases, the TRP 305-a and the TRP 305-b transmit signaling to both the UE 115-c and the UE 115-d using the first set of DMRS ports and/or layers in accordance with an SFN scheme (e.g., using both TCI states) and signaling to one of the UE 115-c or the UE 115-d using the second set of DMRS ports and/or layers and a single TCI state. In some cases, the DMRS port information 320 may indicate a third set of DMRS ports and/or layers in addition to the first and the second set of DMRS ports. The TRP 305-a and the TRP 305-b may transmit signaling to the UE 115-c using the second set of DMRS ports and a TCI state configured for the UE 115-c. Similarly, the TRP 305-a and the TRP 305-b may transmit signaling to the UE 115-d using the third set of DMRS ports and a TCI state configured for the UE 115-d.

In some examples, if the TRP 305-a and the TRP 305-b transmit the NCJT 325 using rate-splitting MU-MIMO techniques, the TRP 305-a and the TRP 305-b may use the first set of DMRS ports for the common stream 335 (e.g., to be received by multiple co-scheduled UEs). Further, the TRP 305-a and/or the TRP 305-b may use the second set of DMRS ports for the private stream 340 to UE 115-c and the third set of DMRS ports for the private stream 340 to the UE 115-d.

In some examples, if the TRP 305-a and the TRP 305-b are implementing rate-splitting techniques for the NCJT 325 to the UE 115-c and the UE 115-d, the DMRS port information 320 may indicate a first set of DMRS ports that are associated with a first TCI sate and are common across multiple co-scheduled UEs (e.g., the common stream 335 for the UE 115-c), a second set of DMRS ports that are associated with a second TCI state and are common across the multiple co-scheduled UEs (e.g., the common stream 335 for the UE 115-d), a third set of DMRS ports that are associated with the first TCI state and are used for communicating a private stream 340 to the UE 115-c, and a fourth set of DMRS ports that are associated with the second TCI state and are used for communicating a private stream 340 to the UE 115-d. In some cases, the first set of DMRS ports and the second set of DMRS ports may be different, such that the TRP 305-a and the TRP 305-b may not use a SFN transmission scheme for the common stream 335.

In some cases, a UE may indicate a capability to support multiple sets of DMRS ports for an NCJT 325. For example, the UE 115-c may transmit a capability message 345 to the TRP 305-a indicating that the UE 115-c may support multiple sets of DMRS ports for the NCJT 325. Additionally, or alternatively, the UE 115-c may transmit the capability message 345 to the TRP 305-b or a network entity. The capability message 345 may indicate whether the UE 115-c supports receiving the NCJT 325 according to rate-splitting techniques using four sets of DMRS ports, rate-splitting techniques using three sets of DMRS ports, or multiple DMRS ports (e.g., regardless of whether the TRP 305-a and the TRP 305-b perform rate splitting).

In some examples, the UE 115-c, the UE 115-d, or both may identify the sets of DMRS ports after receiving the DMRS port information 320 (e.g., DMRS port information indicated by DCI signaling). For example, the UE 115-c, the UE 115-d, or both may identify the first set of DMRS ports, the second set of DMRS ports, the third set of DMRS ports, the fourth set of DMRS ports, or any combination thereof based on a CDM group of the DMRS ports indicated in the DMRS port information 320. That is, the DMRS port information 320 may indicate a list of DMRS ports that includes the sets of DMRS ports. The UE 115-c, the UE 115-d, or both may determine that the DMRS ports in a first CDM group map to the first set of DMRS ports associated with two TCI states (e.g., a first TCI state and a second TCI state), the DMRS ports in a second CDM group map to the second set of DMRS ports associated with the first TCI state, the DMRS ports in a third CDM group map to the third set of DMRS ports associated with the second TCI state, or any combination thereof.

Additionally, or alternatively, the UE 115-c, the UE 115-d, or both may determine the DMRS ports associated with different TCI states are in different CDM groups, but the DMRS ports of the common stream 335 and the private stream 340 may be in a same CDM group. For example, if there are four sets of DMRS ports, the first and the third sets of DMRS ports may be in a first CDM group, while the second and the fourth sets of DMRS ports may be in a second CDM group (e.g., different than the first CDM group). In some other examples, the DMRS ports of the common stream 335 and the private stream 340 may be in different CDM groups, but the DMRS ports associated with different TCI states may be in a same CDM group (e.g., as long as they are both for the private stream 340 or the common stream 335). In some other examples, the DMRs ports of different sets may belong to different CDM groups (e.g., such that there may be four CDM groups if there are four sets of DMRS ports). The UE 115-c, the UE 115-d, or both may determine the mapping between CDM groups and sets of DMRS ports according to a configured, or otherwise defined, association (e.g., rule) between each DMRS port and a CDM group.

In some other examples, the DMRS port information 320 may directly indicate an association between of each scheduled DMRS port with one of the first, second, third, or fourth sets of DMRS ports. For example, one or more fields of the DCI may indicate which DMRS ports belong to each set of DMRS ports (e.g., the first set of DMRS ports, the second set of DMRS ports, the third set of DMRS ports, the fourth set of DMRS ports, or any combination thereof). Additionally, or alternatively, the DMRS port information 320 may indicate a quantity of DMRS ports in each set (e.g., a fixed quantity of DMRS ports), and based on a defined or otherwise configured order of DMRS ports in the DMRS port information 320, the UE 115-c, the UE 115-d, or both may determine whether the scheduled DMRS ports belong to the first, second, third, or fourth sets of DMRS ports. For example, if there are three sets of DMRS ports and the DMRS port information 320 schedules the DMRS ports {0,2,3,4,5}. Assuming the quantity of DMRS ports in a first set of DMRS ports is 1 (e.g., which may be indicated or fixed), the UE 115-c, the UE 115-d, or both may determine that the DMRS port {0} belongs to the first set of DMRS ports. For the second and/or third set of DMRS ports, the UE 115-c, the UE 115-d, or both may perform a similar approach. For example, assuming the quantity of DMRS ports is 2 for each, the UE 115-c, the UE 115-d, or both may determine the DMRS ports {2,3} belong to the second set of DMRS ports and belong to the third set of DMRS ports. Additionally, or alternatively, the UE 115-c, the UE 115-d, or both may determine the sets of DMRS ports based on a CDM group.

In some examples, the UE 115-c, the UE 115-d, or both may map the sets of DMRS ports to one or more codewords. For example, the UE 115-c, the UE 115-d, or both may map the three sets or the four sets of DMRS ports to a same codeword, where the DMRS port information 320 indicates a single set of parameters for the sets of DMRS ports (e.g., a single modulation and coding scheme (MCS), RV, NDI, or the like). In some other examples, if there are three sets of DMRS ports, the UE 115-c, the UE 115-d, or both may map the first set of DMRS ports to a first codeword and the second and third sets of DMRS ports to a second codeword, where the DMRS port information 320 indicates two sets of parameters for the sets of DMRS ports. If there are four sets of DMRS ports, the UE 115-c, the UE 115-d, or both may map the first and the second sets of DMRS ports to a first codeword and the third and fourth sets of DMRS ports to a second codeword, where the DMRS port information 320 indicates two sets of parameters for the sets of DMRS ports. When the TRP 305-a and the TRP 305-b implement rate splitting for the NCJT 325, the first codeword may be a common codeword (e.g., corresponding to a common stream) and the second codeword may be a private codeword (e.g., corresponding to a private stream).

In some cases, such as for four sets of DMRS ports, the first and the third sets of DMRS ports may map to a first codeword and the second and the fourth sets of DMRS ports may map to a second codeword, where the DMRS port information 320 indicates two sets of parameters for the sets of DMRS ports. Thus, the sets of DMRS ports with the same TCI may map to a same codeword. In some examples, each set of DMRS ports may map to a respective codeword (e.g., for three codewords in total if there are three sets of DMRS ports or for four codewords in total if there are four sets of DMRS ports), where the DMRS port information 320 indicates a respective quantity of sets of parameters for the sets of DMRS ports (e.g., three or four sets of parameters). When the TRP 305-a and the TRP 305-b implement rate splitting for the NCJT 325, if there are three sets of DMRS ports, the first codeword may be a common codeword and second and third codewords may be two different private codewords. Similarly, if there are four sets of DMRS ports, the first and second codewords may be different common codewords and the third and fourth codewords may be different private codewords. In some other examples, the UE 115-c or the UE 115-d may determine that the first set of DMRS ports is not mapped to any codeword if there are three sets of DMRS ports or that the first and the second sets of DMRS ports are not mapped to any codeword if there are four sets of DMRS ports, which may be a simplified form of rate splitting. For example, the UE 115-c or the UE 115-d may not decode the common stream 335, but the UE 115-c or the UE 115-d may still perform channel estimation and demodulation for the common stream 335 (e.g., for interference mitigation).

In some examples, the UE 115-c, the UE 115-d, or both may support multiple codeword mapping schemes. Thus, the UE 115-c, the UE 115-d, or both may indicate the one or more supported codeword mapping schemes and/or a network entity may configure one of the codeword mappings (e.g., via RRC signaling). The UE 115-c, the UE 115-d, or both may include the indication of the capability to support the codeword mapping schemes in the capability message 345.

The TRP 305-a, the TRP 305-b, or both may transmit the NCJT 325 in accordance with the DMRS port information 320. In some cases, the TRP 305-a, the TRP 305-b, or both may implement a rate splitting technique for transmitting the NCJT 325, in which the NCJT 325 is split into a common stream 335 and a private stream 340. In some other cases, the TRP 305-a, the TRP 305-b, or both may not implement a rate splitting technique, but may still use multiple sets of DMR ports in accordance with the DMRS port information 320.

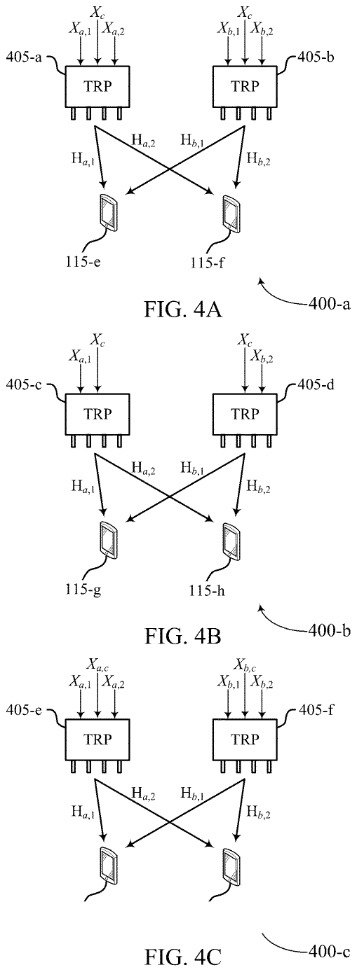

FIGS. 4A, 4B, and 4C illustrate examples of wireless communications systems 400-a, 400-b, and 400-c, respectively, that support rate splitting for an NCJT in accordance with one or more aspects of the present disclosure. In some examples, the wireless communications systems 400-a, 400-b, and 400-c may implement, or be implemented by, aspects of the wireless communications system 100 and the rate splitting diagram 200, and the wireless communications system 300. For example, the wireless communications systems 400-a includes a TRP 405-a, a TRP 405-b, a UE 115-e, and a UE 115-f, which may represent examples of the TRPs and the UEs 115 described with reference to FIGS. 1, 2, and 3. The wireless communications system 400-b includes a TRP 405-c, a TRP 405-d, a UE 115-g, and a UE 115-h, which may represent examples of the TRPs and the UEs 115 described with reference to FIGS. 1, 2, and 3. Likewise, the wireless communications system 400-b includes a TRP 405-e, a TRP 405-f, a UE 115-i, and a UE 115-j, which may represent examples of the TRPs and the UEs 115 described with reference to FIGS. 1, 2, and 3.

In some examples, the TRPs 405 (e.g., TRPs 405-a through 405-f) may perform rate splitting for NCJTs based on using different sets of DMRS ports and/or TCI states for a common portion and a private portion of the NCJT. For example, each TRP 405 may perform NCJT using one or more private streams for respective UEs 115. In particular, a first TRP 405 (e.g., a TRP 405-a, a TRP 405-c, a TRP 405-e) may utilize rate-splitting techniques for transmitting a common stream (e.g., X_{c}, X_{a,c}), a private stream (X_{a,1}) for a first UE 115 (e.g., a UE 115-e, a UE 115-g, a UE 115-i), and a private stream (X_{a,2}) for a second UE 115 (e.g., a UE 115-f, a UE 115-h, a UE 115-j). Likewise, a second TRP 405 (e.g., a TRP 405-b, a TRP 405-d, a TRP 405-f) may utilize rate-splitting techniques for transmitting a common stream (e.g., X_{c}, X_{b,c}), a private stream (X_{b,1}) for the first UE 115, and a private stream (X_{b,2}) for the second UE 115. In some aspects, the private and common streams may be examples of the private and common streams described with reference to FIG. 2 (e.g., streams that have been encoded and modulated, streams that are to be precoded for transmission over a channel).

In the example of FIG. 4A, the TRP 405-a and the TRP 405-b may transmit an NCJT with rate splitting to the UE 115-e and the UE 115-f, where the common streams, X_{c}, may be the same at both TRPs. In such cases, a received signal (e.g., Y₁) at the UE 115-e may be represented by Equation 2:

Y₁=(H_{a,1}P_{a,c}+H_{b,1}P_{b,c})X_{c}+H_{a,1}P_{a,1}X_{a,1}+H_{b,1}P_{b,1}X_{b,1}+1+N₁, (2)

where X_{a,1} is the private stream for the UE 115-e from the TRP 405-a, P_{a,1} is the precoder for the private stream for the UE 115-e and applied by the TRP 405-a, H_{a,1} represents the channel between the TRP 405-a and the UE 115-e, H_{b,1} represents the channel between the TRP 405-b and the UE 115-e, P_{a,c} is the precoder for the common stream for the UE 115-e and applied by the TRP 405-a, and P_{b,c} is the precoder for the common stream for the UE 115-e and applied by the TRP 405-b. Further, I₁ may represent the presence of signaling sent to another UE (e.g., a private stream sent to the UE 115-f) as part of the NCJT. In particular, I₁ may include aspects of a private stream for the UE 115-f and corresponding precoders applied by each TRP (e.g., P_{a,2}, P_{b,2}) applied to the private stream. For instance, I₁ may include H_{a,1}P_{a,2}X_{a,2}+H_{b,1}P_{b,2}X_{b,2}, where X_{a,2} is the private stream for the UE 115-f from the TRP 405-a and X_{b,2} is the private stream for the UE 115-f from the TRP 405-b. In some cases, however, I₁ may be treated as interference (e.g., associated with the transmission to the UE 115-f). The signal received by the UE 115-f from TRP 405-a and the TRP 405-b as part of an NCJT with rate splitting may be similar to the signal Y₁ provided by Equation 2.

In this example, the common portion of the transmission (e.g., the common stream in Y₁ represented by (H_{a,1}P_{a,c}+H_{b,1}P_{b,c})X_{c}) may be transmitted in an SFN manner, whereas the private portion of the transmission (e.g., the private stream of Y₁ represented by H_{a,1}P_{a,1}X_{a,1}+H_{b,1}P_{b,1}X_{b,1}) may be transmitted using NCJT and SDM techniques. Accordingly, a first set of layers and/or DMRS ports may be associated with the common stream may be associated with multiple (e.g., two) TCI states (e.g., each layer/DMRS port in the first set is associated with both TCI states). In addition, a second set of layers/DMRS ports may be associated with one of the multiple TCI states (e.g., one of the two TCI states) and a third set of layers/DMRS ports may be associated with another TCI state of the multiple TCI states (e.g., the other of the two TCI states). In such cases, the first set of layers/DMRS ports (e.g., corresponding to the common stream) may be received by UE 115-e and UE 115-f, and the second set of layers/DMRS ports and the third set of layers/DMRS ports (e.g., corresponding to the private streams) may be received by the respective UEs.

Using rate splitting techniques may reduce inter-cell interference. For example, the TRP 405-a may serve the UE 115-e and the TRP 405-b may serve the UE 115-f, and to prevent inter-cell interference at the UE 115-f from the communications with the UE 115-e and at the UE 115-e from the communications with the UE 115-f, the TRP 405-a and the TRP 405-b may transmit a common message to both the UE 115-e and the UE 115-f. This may reduce, or prevent, interference because each UE may perform channel estimation and interference cancelation based on the signaling from each TRP (e.g., to obtain/1).

In the example of FIG. 4B, the TRP 405-c and the TRP 405-d may transmit an NCJT with rate splitting to the UE 115-g and the UE 115-h, where the common streams, X_{c}, may be the same. In addition, a set of layers may be removed from a particular UE's perspective (e.g., the received signal, Y, may exclude a layer associated with another UE's private stream). Put another way, with respect to the NCJT described with respect to FIG. 4A, each TRP 405 (e.g., TRP 405-c, TRP 405-d) exclude a private stream for another UE 115 in the NCJT of FIG. 4B. Here, the TRP 405-c may (e.g., omit, remove) the private stream, X_{a,2}, associated with the UE 115-h, and the TRP 405-d may exclude (e.g., omit, remove) the private stream, X_{b,1}, associated with the UE 115-g.

In such examples, a received signal (e.g., Y₁) at the UE 115-g may be represented by Equation 3:

Y₁=(H_{a,1}P_{a,c}+H_{b,1}P_{b,c})X_{c}+H_{a,1}P_{a,1}X_{a,1}+I₁+N₁, (3)

where X_{a,1} is the private stream for the UE 115-g from the TRP 405-c, P_{a,1} is the precoder for the private stream for the UE 115-g and applied by the TRP 405-c, H_{a,1} represents the channel between the TRP 405-c and the UE 115-g, H_{b,1} represents the channel between the TRP 405-d and the UE 115-g, P_{a,c} is the precoder for the common stream for the UE 115-g and applied by the TRP 405-c, and P_{b,c} is the precoder for the common stream for the UE 115-g and applied by the TRP 405-d. As described herein, I₁ may represent the presence of signaling sent to another UE (e.g., a private stream sent to the UE 115-h). In some examples, I₁ may be treated as interference (e.g., associated with the transmission to the UE 115-h). The signal received by the UE 115-h from TRP 405-c and the TRP 405-d as part of an NCJT with rate splitting may be similar to the signal Y₁ provided by Equation 3.

In this example, the common portion of the transmission (e.g., the common stream in Y₁ represented by (H_{a,1}P_{a,c}+H_{b,1}P_{b,c})X_{c}) may be transmitted in an SFN manner, whereas the private portion of the transmission (e.g., the private stream of Y1 represented by H_{a,1}P_{a,1}X_{a,1}) may be transmitted in accordance with a particular TCI state. In such cases, a first set of layers and/or DMRS ports may be associated with the common stream may be associated with multiple (e.g., two) TCI states (e.g., each layer/DMRS port in the first set is associated with both TCI states). In addition, a second set of layers/DMRS ports may be associated with one of the multiple TCI states (e.g., one of the two TCI states, a first TCI state or a second TCI state). In such cases, the first set of layers/DMRS ports (e.g., corresponding to the common stream) may be received by UE 115-g and UE 115-h, and the second set of layers/DMRS ports (e.g., corresponding to the private stream) may be received by the respective UEs. However, if one private stream (e.g., either X_{a,2} or X_{b,1}) is removed, then the received signal may be different for a particular UE, and the sets of layers/DMRS ports associated with TCI states may be different (e.g., one of the UEs may receive a transmission via a third set of layers/DMRS ports, as described in the example of FIG. 4A).

In the example of FIG. 4C, the TRP 405-e and the TRP 405-f may transmit an NCJT with rate splitting to the UE 115-i and the UE 115-j, where the common streams may be different. For instance, the common stream at the TRP 405-e may be X_{a,c} and the common stream at the TRP 405-f may be X_{b,c}, where X_{a,c} and X_{b,c} are different (e.g., different codewords). In such examples, a received signal (e.g., Y₁) at the UE 115-i may be represented by Equation 4:

Y₁=H_{a,1}P_{a,c}X_{a,c}+H_{b,1}P_{b,c}X_{b,c}+H_{a,1}P_{a,1}X_{a,1}+H_{b,1}P_{b,1}X_{b,1}+I₁+N₁, (4)

where X_{a,1} is the private stream for the UE 115-i from the TRP 405-e, P_{a,1} is the precoder for the private stream for the UE 115-i and applied by the TRP 405-e, H_{a,1} represents the channel between the TRP 405-e and the UE 115-i, H_{b,1} represents the channel between the TRP 405-f and the UE 115-i, P_{a,c} is the precoder for the common stream for the UE 115-i and applied by the TRP 405-e, and P_{b,c} is the precoder for the common stream for the UE 115-i and applied by the TRP 405-f. Further, I₁ may represent the presence of signaling sent to another UE (e.g., a private stream sent to the UE 115-j) as part of the NCJT, and I₁ may represent aspects of a private stream for the UE 115-j and corresponding precoders applied by each TRP (e.g., P_{a,2}, P_{b,2}) applied to the private stream. For example, I₁ may include H_{a,1}P_{a,2}X_{a,2}+H_{b,1}P_{b,2}X_{b,2}, where X_{a,2} is the private stream for the UE 115-j from the TRP 405-e and X_{b,2} is the private stream for the UE 115-j from the TRP 405-f. In some cases, I₁ may be treated as interference (e.g., associated with the transmission to the UE 115-j). The signal received by the UE 115-j from TRP 405-a and the TRP 405-f as part of an NCJT with rate splitting may be similar to the signal Y₁ provided by Equation 4.

In this example, the common portion of the transmission (e.g., the common stream in Y₁ represented by H_{a,1}P_{a,c}X_{a,c}+H_{b,1}P_{b,c}X_{b,c}) may be transmitted using NCJT in an SDM manner, and the private portion of the transmission (e.g., the private stream of Y₁ represented by H_{a,1}P_{a,1}X_{a,1}+H_{b,1}P_{b,1}X_{b,1}) may also be transmitted using SDM techniques. In such cases, a first set of layers/DMRS ports may be associated with a first TCI state and may be common across multiple co-scheduled UEs (UE 115-i and UE 115-j) (e.g., corresponding to the common stream), a second set of layers/DMRS ports may be associated with a second TCI state and may be common across the multiple co-scheduled UEs (e.g., corresponding to the common stream), a third set of layers/DMRS ports may be associated with the first TCI state (e.g., corresponding to a private stream), and a fourth set of layers/DMRS ports are associated with the second TCI state (e.g., corresponding to a private stream).

As described herein, a UE 115 may signal its capability to support the signaling schemes described with reference to FIGS. 4A, 4B, and 4C. As such, a network entity may configure such transmissions based on the capability of one or more UEs 115 in a system.

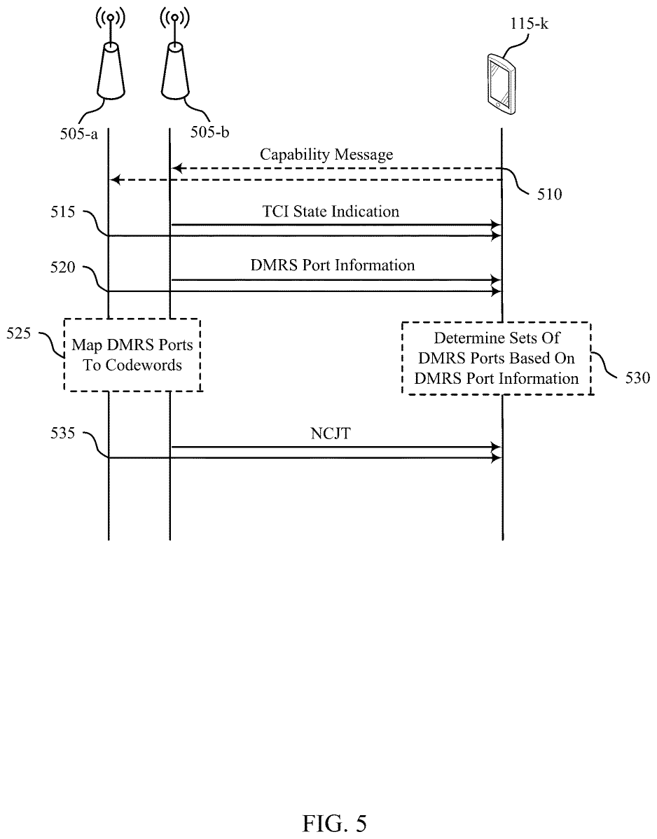

FIG. 5 illustrates an example of a process flow 500 that supports rate splitting for an NCJT in accordance with one or more aspects of the present disclosure. The process flow 500 may be implemented by aspects of the wireless communications system 100, the rate splitting diagram 200, wireless communications system 300, the wireless communications system 400-a, the wireless communications system 400-b, and the wireless communications system 400-c. For example, the process flow 500 may illustrate a TRP 505-a, a TRP 505-b, or both communicating with a UE 115-k, where the TRP 505-a, the TRP 505-b, and the UE 115-k may be examples of corresponding devices described herein, including with reference to FIGS. 1, 2, 3, 4A, 4B, and 4C. In some aspects, the process flow 500 may support techniques for rate splitting with NCJT, where a first set of DMRS ports and/or layers may be associated with multiple (e.g., two) TCI states, a second set of DMRS ports and/or layers may be associated with one TCI state of the multiple TCI states, and a third set of DMRS ports and/or layers may be associated with another TCI state of the multiple TCI states, which may support a transmission of a common stream using an SFN transmission scheme.

In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time.

In some cases, at 510, the UE 115-k may transmit a capability message indicating a capability of the UE 115-k to receive an NCJT using multiple sets of DMRS ports (e.g., a first set of DMRS ports and a second set of DMRS ports) and/or layers that are associated with various TCI states. Additionally, or alternatively, the capability message indicates a capability of the UE 115-k to support one or more codeword mapping schemes for the multiple sets of DMRS ports.

At 515, the TRP 505-a, the TRP 505-b, or both may transmit first signaling to the UE 115-k indicating TCI states for the NCJT from a plurality of TRPs. The first signaling may be RRC signaling or a MAC-CE.

At 520, the TRP 505-a, the TRP 505-b, or both may transmit second signaling to the UE 115-k that schedules the NCJT using the multiple sets of DMRS ports. For example, the second signaling may indicate the first set of DMRS ports and the second set of DMRS ports. The second signaling may be a DCI message that indicates a list of scheduled, or available, DMRS ports including the multiple sets of DMRS ports. In some cases, the TRP 505-a, the TRP 505-b, or both may use the first set of DMRS ports for communications using two or more TCI states and the second set of DMRS ports for communications using a first TCI state of the two or more TCI states. The NCJT may be scheduled using the first set of DMRS ports and the second set of DMRS ports in accordance with the capability of the UE 115-k. In some examples, the second signaling may schedule the NCJT using a third set of DMRS ports for communications using a second TCI state of the two or more TCI states.

In some examples, at 525, the TRP 505-a, the TRP 505-b, or both may map a single codeword to the first set of DMRS ports and the second set of DMRS ports, where the second signaling indicates one or more parameters for the single codeword (e.g., MCS, RV, NDI, or any other parameter).

In some other examples, the TRP 505-a, the TRP 505-b, or both may map a first codeword to the first set of DMRS ports and a second codeword to the second set of DMRS ports, where the second signaling indicates a first set of parameters for the first codeword and a second set of parameters for the second codeword.

In some cases, the first set of DMRS ports excludes a mapping to a codeword. Instead, the TRP 505-a, the TRP 505-b, or both may map the codeword to the second set of DMRS ports, where the second signaling indicates a set of parameters for the codeword.

In some other cases, if the second signaling schedules the NCJT using a third set of DMRS ports, the TRP 505-a, the TRP 505-b, or both may map a first codeword to the first set of DMRS ports, a second codeword to the second set of DMRS ports and the third set of DMRS ports, where the second signaling indicates a first set of parameters for the first codeword and a second set of parameters for the second codeword.

In some examples, if the second signaling schedules the NCJT using a third set of DMRS ports, the TRP 505-a, the TRP 505-b, or both may map a first codeword to the first set of DMRS ports, a second codeword to the second set of DMRS ports, and a third codeword to the third set of DMRS ports, where the second signaling indicates a first set of parameters for the first codeword, a second set of parameters for the second codeword, and a third set of parameters for the third codeword.

In some cases, at 530, the UE 115-k may determine the different sets of DMRS ports based on the DMRS port information at 520. For example, the UE 115-k may determine the first set of DMRS ports based on a first CDM group and the second set of DMRS ports based on a second CDM group (e.g., different from the first CDM group) in accordance with a mapping, or defined rule, between the first set of DMRS ports and the first CDM group and between the second set of DMRS ports and the second CDM group. In some other examples, the UE 115-k may determine the sets of DMRS ports based on the second signaling explicitly indicating the first set of DMRS ports and the second set of DMRS ports in one or more fields.

In some cases, the UE 115-k may determine the first set of DMRS ports and the second set of DMRS ports based on an order of the first set of DMRS ports and the second set of DMRS ports and a respective quantity of DMRS ports in each of the first set of DMRS ports and the second set of DMRS ports, where the second signaling indicates the respective quantity of DMRS ports in each of the first set of DMRS ports and the second set of DMRS ports.

At 535, the UE 115-k may receive the NCJT in accordance with the two or more TCI states. In some cases, the NCJT may include at least a first portion with information common to multiple UEs including the UE 115-k and a second portion including information specific to the UE 115-k. The first portion may be a common stream and the second portion may be a private stream. The TRP 505-a, the TRP 505-b, or both may use the first set of DMRS ports for the first portion of the NCJT and the second set of DMRS ports for the second portion of the NCJT.

If the second signaling schedules the NCJT using a third set of DMRS ports, the TRP 505-a, the TRP 505-b, or both may use the first set of DMRS ports for the first portion of the NCJT, the second set of DMRS ports for the second portion of the NCJT, and the third set of DMRS ports for the second portion of the NCJT.

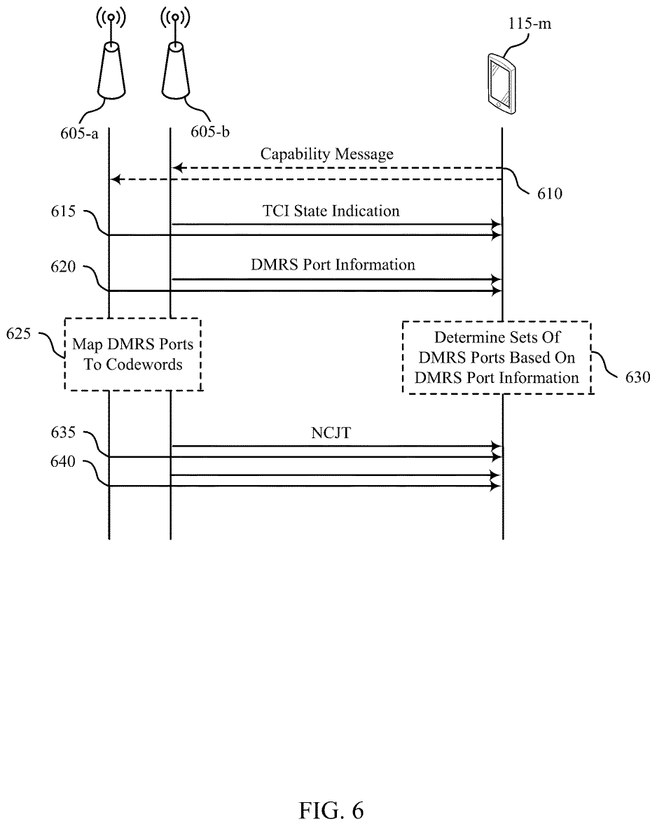

FIG. 6 illustrates an example of a process flow 600 that supports rate splitting for an NCJT in accordance with one or more aspects of the present disclosure. The process flow 600 may be implemented by aspects of the wireless communications system 100, the rate splitting diagram 200, the wireless communications system 300, the wireless communications system 400-a, the wireless communications system 400-b, and the wireless communications system 400-c. For example, the process flow 600 may illustrate a TRP 605-a, a TRP 605-b, or both communicating with a UE 115-m, where the TRP 605-a, the TRP 605-b, and the UE 115-m may be examples of corresponding devices described herein, including with reference to FIGS. 1, 2, 3, 4A, 4B, and 4C. In some aspects, the process flow 600 may support techniques for rate splitting with NCJT, where different sets of DMRS ports and/or layers may be associated with respective TCI states, which may correspond to a transmission of a common stream using an SDM scheme.

In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

In some cases, at 610, the UE 115-m may transmit a capability message indicating a capability of the UE 115-m to receive an NCJT using multiple sets of DMRS ports (e.g., a first set of DMRS ports, a second set of DMRS ports, a third set of DMRS ports, and a fourth set of DMRS ports) and/or layers that are each associated with a TCI state (e.g., either a first TCI state or a second TCI state). Additionally, or alternatively, the capability message indicates a capability of the UE 115-m to support one or more codeword mapping schemes for the multiple sets of DMRS ports.

At 615, the TRP 605-a, the TRP 605-b, or both may transmit first signaling to the UE 115-m indicating TCI states for the NCJT from multiple TRPs. In some cases, the NCJT may include at least a first portion (e.g., a common stream) including first information common to multiple UEs including the UE 115-m and a second portion (e.g., a private stream) including information specific to the UE 115-m. The first signaling may be RRC signaling or a MAC-CE.

At 620, the TRP 605-a, the TRP 605-b, or both may transmit second signaling to the UE 115-m that schedules the NCJT using the multiple sets of DMRS ports. For example, the second signaling may indicate the TRP 605-a, the TRP 605-b, or both may use a first set of DMRS ports for communications using a first TCI state, a second set of DMRS ports for communications using a second TCI state, a third set of DMRS ports for communications using the first TCI state, and a fourth set of DMRS ports for communications using the second TCI state. The second signaling may be a DCI message that indicates a list of scheduled, or available, DMRS ports including the multiple sets of DMRS ports. In some cases, the TRP 605-a, the TRP 605-b, or both may use the first set of DMRS ports and the second set of DMRS ports for the common stream, the third set of DMRS ports for the private stream to the UE 115-m, and the fourth set of the DMRS ports for another private stream to a different UE. The NCJT may be scheduled using the first set of DMRS ports, the second set of DMRS ports, the third set of DMRS ports, and the fourth set of DMRS ports in accordance with the capability of the UE 115-m.

In some examples, at 625, the TRP 605-a, the TRP 605-b, or both may map a single codeword to the first set of DMRS ports, the second set of DMRS ports, the third set of DMRS ports, and the fourth set of DMRS ports, where the second signaling indicates one or more parameters for the single codeword (e.g., MCS, RV, NDI, or any other parameter).

In some other examples, the TRP 605-a, the TRP 605-b, or both may map a first codeword to the first set of DMRS ports and the second set of DMRS ports, a second codeword to the third set of DMRS ports and the fourth set of DMRS ports based on a mapping of a set of DMRS ports to a respective codeword for each respective portion of the NCJT, where the second signaling indicates a first set of parameters for the first codeword and a second set of parameters for the second codeword.

In some cases, the TRP 605-a, the TRP 605-b, or both may map a first codeword to the first set of DMRS ports and the third set of DMRS ports, a second codeword to the second set of DMRS ports and the fourth set of DMRS ports based on a mapping of a set of DMRS ports to a respective codeword for each TCI state, where the second signaling indicates a first set of parameters for the first codeword and a second set of parameters for the second codeword.

In some other cases, the TRP 605-a, the TRP 605-b, or both may map a first codeword to the first set of DMRS ports, a second codeword to the second set of DMRS ports, a third codeword to the third set of DMRS ports, and a fourth codeword to the fourth set of DMRS ports, where the second signaling indicates a first set of parameters for the first codeword, a second set of parameters for the second codeword, a third set of parameters for the third codeword, and a fourth set of parameters for the fourth codeword.

In some examples, the first set of DMRS ports, the second set of DMRS ports, or both may exclude a mapping to one or more codewords. Instead, the TRP 605-a, the TRP 605-b, or both may map the one or more codewords to the third set of DMRS ports and the fourth set of DMRS ports, where the second signaling indicates a set of parameters for the one or more codewords.

In some cases, at 630, the UE 115-m may determine the different sets of DMRS ports based on the DMRS port information at 620. For example, the UE 115-m may determine the first set of DMRS ports, the second set of DMRS ports, the third set of DMRS ports, and the fourth set of DMRS ports based on one or more CDM groups and in accordance with a mapping, or defined rule, between the first set of DMRS ports and the one or more CDM groups, between the second set of DMRS ports and the one or more CDM groups, the third set of DMRS ports and the one or more CDM groups, and the fourth set of DMRS ports and the one or more CDM groups.

In some cases, the first set of DMRS ports and the second set of DMRS ports may map to a first CDM group and the third set of DMRS ports and the fourth set of DMRS ports may map to a second CDM group based on the mapping of a set of DMRS ports to a respective CDM group being based on a respective portion of the NCJT. In some other cases, the first set of DMRS ports and the third set of DMRS ports may map to a first CDM group and the second set of DMRS ports and the fourth set of DMRS ports may map to a second CDM group (e.g., different from the first CDM group) based on the mapping of a set of DMRS ports to a respective CDM group being based on a respective TCI state for the set of DMRS ports. In some examples, the first set of DMRS ports may map to a first CDM group, the second set of DMRS ports may map to a second CDM group, the third set of DMRS ports may map to a third CDM group, and the fourth set of DMRS ports may map to a fourth CDM group based on the mapping of a set of DMRS ports to a respective CDM group being on a per set of DMRS ports basis.

In some other examples, the UE 115-m may determine the sets of DMRS ports based on the second signaling explicitly indicating the first set of DMRS ports, the second set of DMRS ports, the third set of DMRS ports, and the fourth set of DMRS ports in one or more fields.

In some cases, the UE 115-m may determine the first set of DMRS ports, the second set of DMRS ports, the third set of DMRS ports, and the fourth set of DMRS ports based on an order of the sets of DMRS ports and a respective quantity of DMRS ports in each of the first set of DMRS ports, the second set of DMRS ports, the third set of DMRS ports, and the fourth set of DMRS ports, where the second signaling indicates the respective quantity of DMRS ports in each set of DMRS ports.

At 635 and 640, the UE 115-m may receive the first portion of the NCJT and the second portion of the NCJT, respectively, in accordance with the first TCI state.

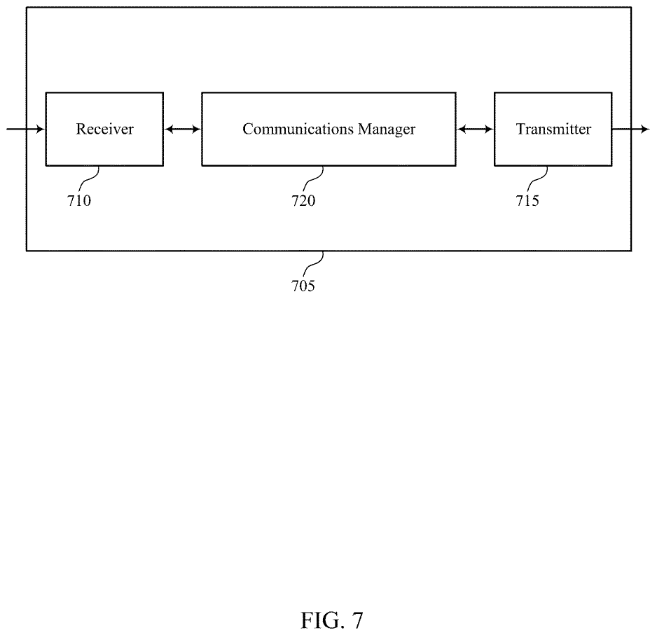

FIG. 7 illustrates a block diagram 700 of a device 705 that supports rate splitting for an NCJT in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to rate splitting for an NCJT). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to rate splitting for an NCJT). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of rate splitting for an NCJT as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving first signaling indicating a set of multiple TCI states for an NCJT from a set of multiple TRPs. The communications manager 720 may be configured as or otherwise support a means for receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The communications manager 720 may be configured as or otherwise support a means for receiving the NCJT in accordance with the two or more TCI states.

Additionally, or alternatively, the communications manager 720 may support wireless communication at a UE in accordance with examples as disclosed herein. For example, the communications manager 720 may be configured as or otherwise support a means for receiving first signaling indicating a set of multiple TCI states for an NCJT from a set of multiple TRPs, the NCJT including at least a first portion including first information common to a set of multiple UEs including the UE and a second portion including information specific to the UE. The communications manager 720 may be configured as or otherwise support a means for receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The communications manager 720 may be configured as or otherwise support a means for receiving the NCJT in accordance with the first TCI state.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for one or more TRPs to transmit control signaling indicating DMRS port information for a UE 115 to use for receiving an NCJT, which may provide for reduced processing, reduced power consumption, more efficient utilization of communication resources, or the like.

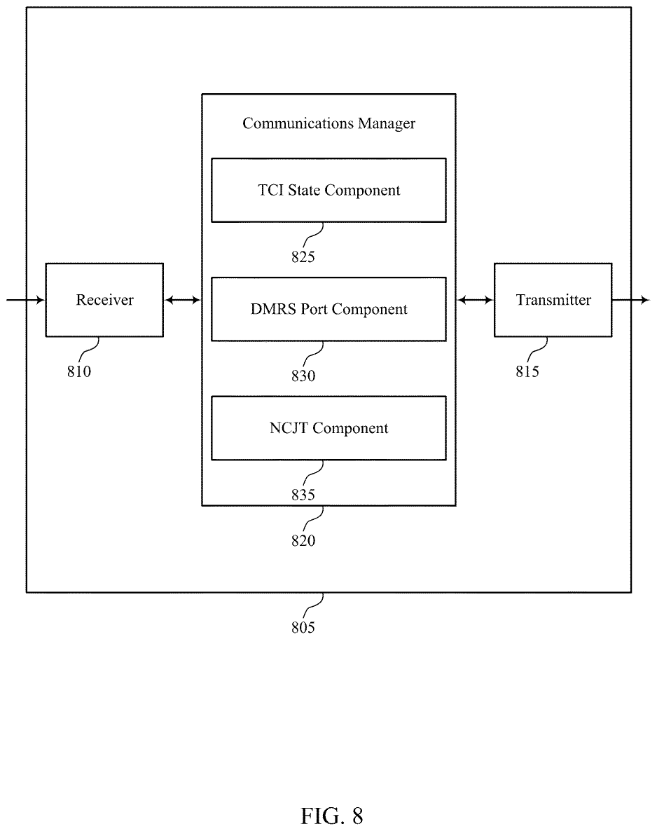

FIG. 8 illustrates a block diagram 800 of a device 805 that supports rate splitting for an NCJT in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to rate splitting for an NCJT). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to rate splitting for an NCJT). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of rate splitting for an NCJT as described herein. For example, the communications manager 820 may include a TCI state component 825, a DMRS port component 830, an NCJT component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The TCI state component 825 may be configured as or otherwise support a means for receiving first signaling indicating a set of multiple TCI states for an NCJT from a set of multiple TRPs. The DMRS port component 830 may be configured as or otherwise support a means for receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The NCJT component 835 may be configured as or otherwise support a means for receiving the NCJT in accordance with the two or more TCI states.

Additionally, or alternatively, the communications manager 820 may support wireless communication at a UE in accordance with examples as disclosed herein. The TCI state component 825 may be configured as or otherwise support a means for receiving first signaling indicating a set of multiple TCI states for an NCJT from a set of multiple TRPs, the NCJT including at least a first portion including first information common to a set of multiple UEs including the UE and a second portion including information specific to the UE. The DMRS port component 830 may be configured as or otherwise support a means for receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The NCJT component 835 may be configured as or otherwise support a means for receiving the NCJT in accordance with the first TCI state.

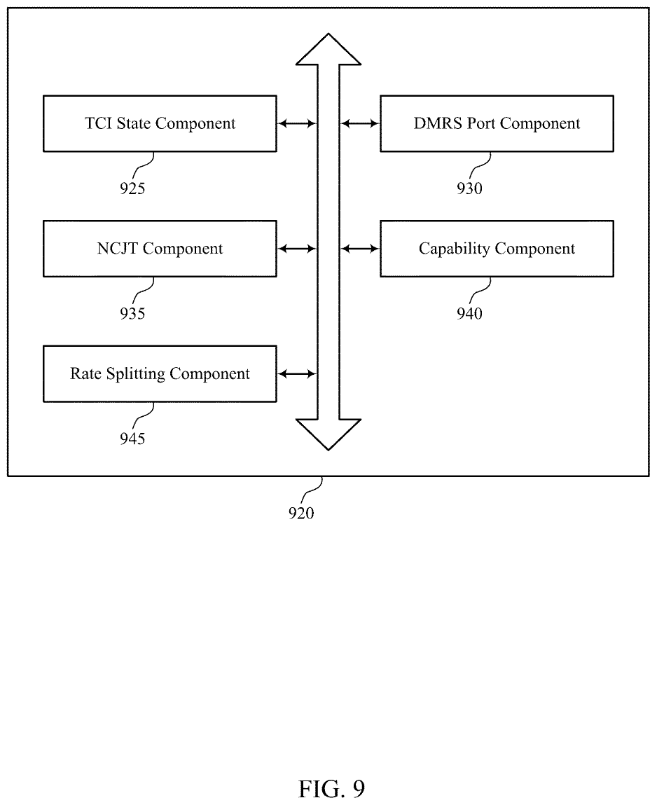

FIG. 9 illustrates a block diagram 900 of a communications manager 920 that supports rate splitting for an NCJT in accordance with one or more aspects of the present disclosure. The communications manager 920 may be an example of aspects of a communications manager 720, a communications manager 820, or both, as described herein. The communications manager 920, or various components thereof, may be an example of means for performing various aspects of rate splitting for an NCJT as described herein. For example, the communications manager 920 may include a TCI state component 925, a DMRS port component 930, an NCJT component 935, a capability component 940, a rate splitting component 945, or any combination thereof. Each of these components may communicate, directly or indirectly, with one another (e.g., via one or more buses).

The communications manager 920 may support wireless communication at a UE in accordance with examples as disclosed herein. The TCI state component 925 may be configured as or otherwise support a means for receiving first signaling indicating a set of multiple TCI states for an NCJT from a set of multiple TRPs. The DMRS port component 930 may be configured as or otherwise support a means for receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The NCJT component 935 may be configured as or otherwise support a means for receiving the NCJT in accordance with the two or more TCI states.

In some examples, the capability component 940 may be configured as or otherwise support a means for transmitting a capability message indicating a capability of the UE to receive the NCJT using the first set of DMRS ports and the second set of DMRS ports, where the NCJT is scheduled using the first set of DMRS ports and the second set of DMRS ports based on the capability of the UE.

In some examples, the capability message indicates a capability of the UE to support one or more codeword mapping schemes for the first set of DMRS ports and the second set of DMRS ports.

In some examples, the NCJT includes at least a first portion including first information common to a set of multiple UEs including the UE and a second portion including information specific to the UE. In some examples, the first set of DMRS ports corresponds to the first portion of the NCJT and the second set of DMRS ports corresponds to the second portion of the NCJT.

In some examples, the DMRS port component 930 may be configured as or otherwise support a means for determining, in accordance with a mapping between the first set of DMRS ports and a first code division multiplexing group, the first set of DMRS ports based on the first code division multiplexing group. In some examples, the DMRS port component 930 may be configured as or otherwise support a means for determining, in accordance with a mapping between the second set of DMRS ports and a second code division multiplexing group, the second set of DMRS ports based on the second code division multiplexing group. In some examples, the second code division multiplexing group is different from the first code division multiplexing group.

In some examples, one or more fields of the second signaling indicate the first set of DMRS ports and the second set of DMRS ports.

In some examples, the DMRS port component 930 may be configured as or otherwise support a means for determining the first set of DMRS ports and the second set of DMRS ports based on an order of the first set of DMRS ports and the second set of DMRS ports and a respective quantity of DMRS ports in each of the first set of DMRS ports and the second set of DMRS ports, where the second signaling indicates the respective quantity of DMRS ports in each of the first set of DMRS ports and the second set of DMRS ports.

In some examples, a single codeword corresponds to the first set of DMRS ports and the second set of DMRS ports. In some examples, the second signaling indicates one or more parameters associated with the single codeword.

In some examples, a first codeword corresponds to the first set of DMRS ports. In some examples, a second codeword corresponds to the second set of DMRS ports. In some examples, the second signaling indicates a first set of parameters associated with the first codeword and a second set of parameters associated with the second codeword.

In some examples, the first set of DMRS ports excludes a mapping to a codeword. In some examples, the codeword corresponds to the second set of DMRS ports. In some examples, the second signaling indicates a set of parameters associated with the codeword.

In some examples, the second signaling further schedules the NCJT using a third set of DMRS ports associated with a second TCI state of the two or more TCI states.

In some examples, the NCJT includes at least a first portion including first information common to a set of multiple UEs including the UE and a second portion including information specific to the UE. In some examples, the first set of DMRS ports corresponds to the first portion of the NCJT, the second set of DMRS ports corresponds to the second portion of the NCJT, and the third set of DMRS ports correspond to the second portion of the NCJT.

In some examples, a first codeword corresponds to the first set of DMRS ports. In some examples, a second codeword corresponds to the second set of DMRS ports and the third set of DMRS ports. In some examples, the second signaling indicates a first set of parameters associated with the first codeword and a second set of parameters associated with the second codeword.

In some examples, a first codeword corresponds to the first set of DMRS ports. In some examples, a second codeword corresponds to the second set of DMRS ports. In some examples, a third codeword corresponds to the third set of DMRS ports. In some examples, the second signaling indicates a first set of parameters associated with the first codeword, a second set of parameters associated with the second codeword, and a third set of parameters associated with the third codeword.

Additionally, or alternatively, the communications manager 920 may support wireless communication at a UE in accordance with examples as disclosed herein. In some examples, the TCI state component 925 may be configured as or otherwise support a means for receiving first signaling indicating a set of multiple TCI states for an NCJT from a set of multiple TRPs, the NCJT including at least a first portion including first information common to a set of multiple UEs including the UE and a second portion including information specific to the UE. In some examples, the DMRS port component 930 may be configured as or otherwise support a means for receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. In some examples, the NCJT component 935 may be configured as or otherwise support a means for receiving the NCJT in accordance with the first TCI state.

In some examples, the capability component 940 may be configured as or otherwise support a means for transmitting a capability message indicating a capability of the UE to receive the NCJT using the first set of DMRS ports, the second set of DMRS ports, the third set of DMRS ports, and the fourth set of DMRS ports, where the NCJT is scheduled using the first set of DMRS ports, the second set of DMRS ports, the third set of DMRS ports, and the fourth set of DMRS ports based on the capability of the UE.

In some examples, the capability message indicates a capability of the UE to support one or more codeword mapping schemes for the first set of DMRS ports, the second set of DMRS ports, the third set of DMRS ports, the fourth set of DMRS ports, or any combination thereof.

In some examples, the DMRS port component 930 may be configured as or otherwise support a means for determining the first set of DMRS ports, the second set of DMRS ports, the third set of DMRS ports, and the fourth set of DMRS ports based on one or more code division multiplexing groups and in accordance with a mapping between the first set of DMRS ports and the one or more code division multiplexing groups, the second set of DMRS ports and the one or more code division multiplexing groups, the third set of DMRS ports and the one or more code division multiplexing groups, and the fourth set of DMRS ports and the one or more code division multiplexing groups.

In some examples, the first set of DMRS ports and the second set of DMRS ports map to a first code division multiplexing group. In some examples, the third set of DMRS ports and the fourth set of DMRS ports map to a second code division multiplexing group based on the mapping of a set of DMRS ports to a respective code division multiplexing group corresponding to a respective portion of the NCJT.

In some examples, the first set of DMRS ports and the third set of DMRS ports map to a first code division multiplexing group. In some examples, the second set of DMRS ports and the fourth set of DMRS ports map to a second code division multiplexing group different from the first code division multiplexing group based on the mapping of a set of DMRS ports to a respective code division multiplexing group corresponding to a respective TCI state associated with the set of DMRS ports.

In some examples, the first set of DMRS ports map to a first code division multiplexing group. In some examples, the second set of DMRS ports map to a second code division multiplexing group. In some examples, the third set of DMRS ports map to a third code division multiplexing group. In some examples, the fourth set of DMRS ports map to a fourth code division multiplexing group based on the mapping of a set of DMRS ports to a respective code division multiplexing group being on a per set of DMRS ports basis.

In some examples, one or more fields of the second signaling indicate the first set of DMRS ports, the second set of DMRS ports, the third set of DMRS ports, and the fourth set of DMRS ports.

In some examples, the DMRS port component 930 may be configured as or otherwise support a means for determining the first set of DMRS ports, the second set of DMRS ports, the third set of DMRS ports, and the fourth set of DMRS ports based on the second signaling indicating a respective quantity of DMRS ports in each of the first set of DMRS ports, the second set of DMRS ports, the third set of DMRS ports, and the fourth set of DMRS ports.

In some examples, a single codeword corresponds to the first set of DMRS ports, the second set of DMRS ports, the third set of DMRS ports, and the fourth set of DMRS ports. In some examples, the second signaling indicates one or more parameters associated with the single codeword.

In some examples, a first codeword corresponds to the first set of DMRS ports and the second set of DMRS ports. In some examples, a second codeword corresponding to the third set of DMRS ports and the fourth set of DMRS ports based on a mapping of a set of DMRS ports to a respective codeword corresponding to a respective portion of the NCJT. In some examples, the second signaling indicates a first set of parameters associated with the first codeword and a second set of parameters associated with the second codeword.

In some examples, a first codeword corresponds to the first set of DMRS ports and the third set of DMRS ports. In some examples, a second codeword corresponding to the second set of DMRS ports and the fourth set of DMRS ports based on a mapping of a set of DMRS ports to a respective codeword corresponding to a respective TCI state. In some examples, the second signaling indicates a first set of parameters associated with the first codeword and a second set of parameters associated with the second codeword.

In some examples, a first codeword corresponds to the first set of DMRS ports. In some examples, a second codeword corresponds to the second set of DMRS ports. In some examples, a third codeword corresponds to the third set of DMRS ports. In some examples, a fourth codeword corresponds to the fourth set of DMRS ports. In some examples, the second signaling indicates a first set of parameters associated with the first codeword, a second set of parameters associated with the second codeword, a third set of parameters associated with the third codeword, and a fourth set of parameters associated with the fourth codeword.

In some examples, the first set of DMRS ports, the second set of DMRS ports, or both exclude a mapping to one or more codewords. In some examples, the one or more codewords correspond to the third set of DMRS ports and the fourth set of DMRS ports. In some examples, the second signaling indicates respective sets of parameters associated with the one or more codewords.

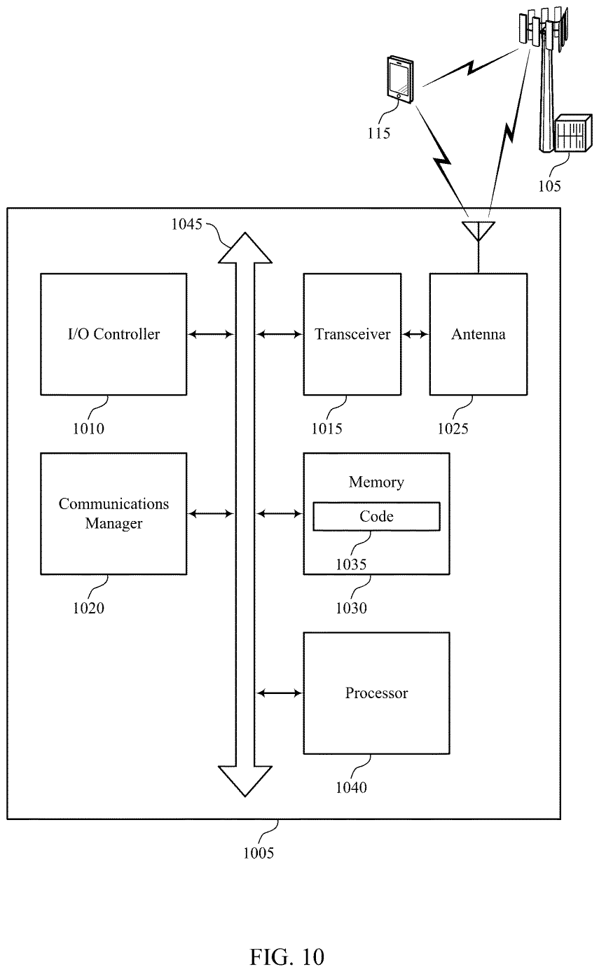

FIG. 10 illustrates a diagram of a system 1000 including a device 1005 that supports rate splitting for an NCJT in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting rate splitting for an NCJT). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving first signaling indicating a set of multiple TCI states for an NCJT from a set of multiple TRPs. The communications manager 1020 may be configured as or otherwise support a means for receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The communications manager 1020 may be configured as or otherwise support a means for receiving the NCJT in accordance with the two or more TCI states.

Additionally, or alternatively, the communications manager 1020 may support wireless communication at a UE in accordance with examples as disclosed herein. For example, the communications manager 1020 may be configured as or otherwise support a means for receiving first signaling indicating a set of multiple TCI states for an NCJT from a set of multiple TRPs, the NCJT including at least a first portion including first information common to a set of multiple UEs including the UE and a second portion including information specific to the UE. The communications manager 1020 may be configured as or otherwise support a means for receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The communications manager 1020 may be configured as or otherwise support a means for receiving the NCJT in accordance with the first TCI state.

By including or configuring the communications manager 1020 in accordance with examples as described herein, the device 1005 may support techniques for one or more TRPs to transmit control signaling indicating DMRS port information for a UE 115 to use for receiving an NCJT, which may provide for improved communication reliability, reduced latency, improved user experience related to reduced processing, reduced power consumption, more efficient utilization of communication resources, improved coordination between devices, longer battery life, improved utilization of processing capability, or the like.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of rate splitting for an NCJT as described herein, or the processor 1040 and the memory 1030 may be otherwise configured to perform or support such operations.

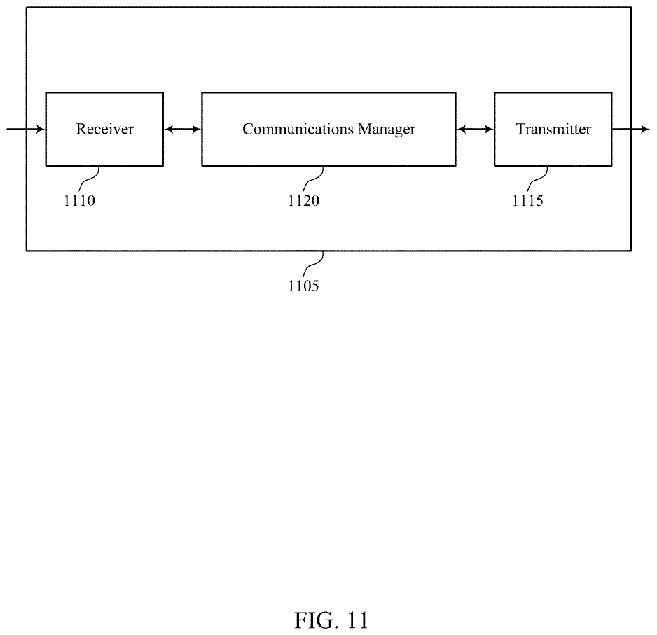

FIG. 11 illustrates a block diagram 1100 of a device 1105 that supports rate splitting for an NCJT in accordance with one or more aspects of the present disclosure. The device 1105 may be an example of aspects of an TRP as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of rate splitting for an NCJT as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a TRP in accordance with examples as disclosed herein. For example, the communications manager 1120 may be configured as or otherwise support a means for transmitting first signaling indicating a set of multiple TCI states for an NCJT from a set of multiple TRPs including the TRP. The communications manager 1120 may be configured as or otherwise support a means for transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The communications manager 1120 may be configured as or otherwise support a means for transmitting the NCJT in accordance with the two or more TCI states.

Additionally, or alternatively, the communications manager 1120 may support wireless communication at a TRP in accordance with examples as disclosed herein. For example, the communications manager 1120 may be configured as or otherwise support a means for transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs. The communications manager 1120 may be configured as or otherwise support a means for transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The communications manager 1120 may be configured as or otherwise support a means for transmitting the NCJT in accordance with the first TCI state and the second TCI state.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for one or more TRPs to transmit control signaling indicating DMRS port information for a UE 115 to use for receiving an NCJT, which may provide for reduced processing, reduced power consumption, more efficient utilization of communication resources, or the like.

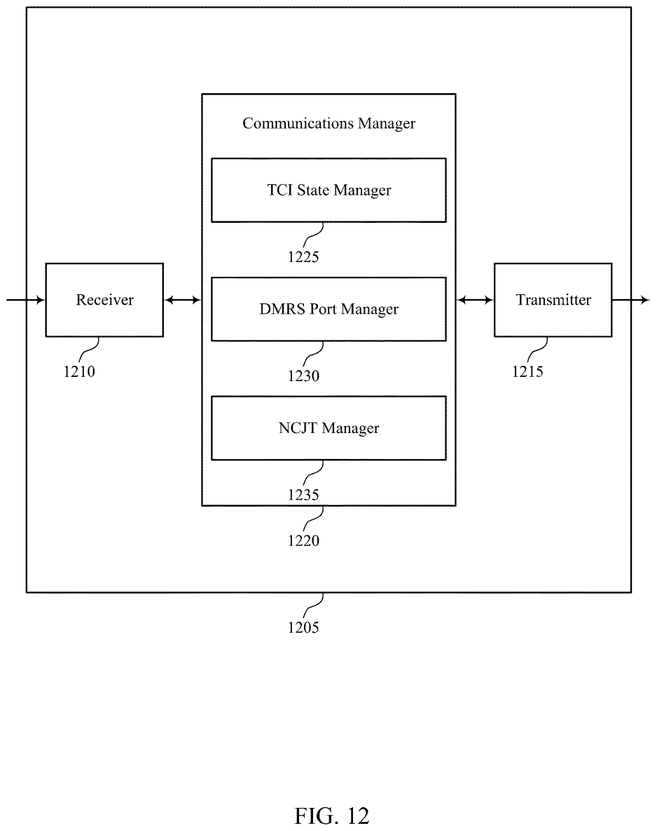

FIG. 12 illustrates a block diagram 1200 of a device 1205 that supports rate splitting for an NCJT in accordance with one or more aspects of the present disclosure. The device 1205 may be an example of aspects of a device 1105 or a TRP (e.g., a network entity 105) as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of rate splitting for an NCJT as described herein. For example, the communications manager 1220 may include a TCI state manager 1225, a DMRS port manager 1230, an NCJT manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a TRP in accordance with examples as disclosed herein. The TCI state manager 1225 may be configured as or otherwise support a means for transmitting first signaling indicating a set of multiple TCI states for an NCJT from a set of multiple TRPs including the TRP. The DMRS port manager 1230 may be configured as or otherwise support a means for transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The NCJT manager 1235 may be configured as or otherwise support a means for transmitting the NCJT in accordance with the two or more TCI states.

Additionally, or alternatively, the communications manager 1220 may support wireless communication at a TRP in accordance with examples as disclosed herein. The TCI state manager 1225 may be configured as or otherwise support a means for transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs. The DMRS port manager 1230 may be configured as or otherwise support a means for transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The NCJT manager 1235 may be configured as or otherwise support a means for transmitting the NCJT in accordance with the first TCI state and the second TCI state.

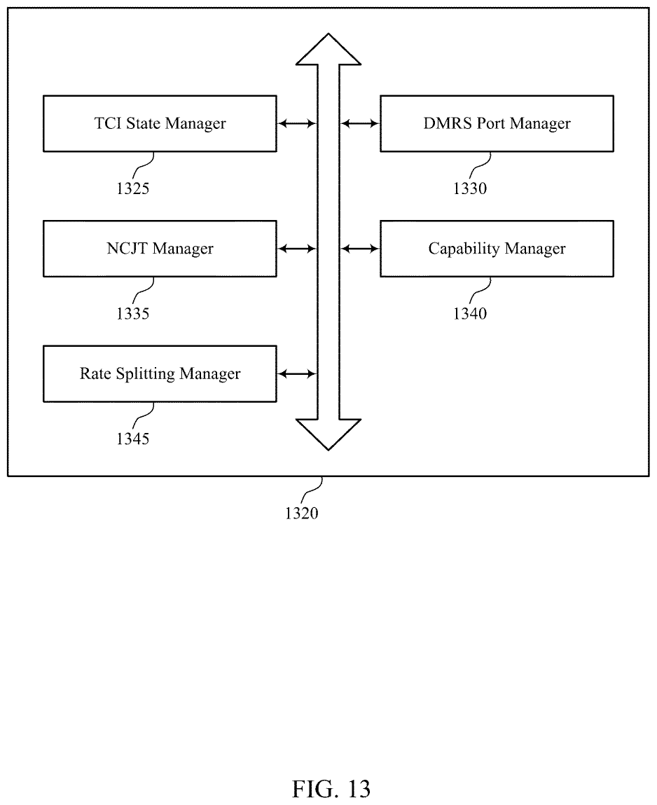

FIG. 13 illustrates a block diagram 1300 of a communications manager 1320 that supports rate splitting for an NCJT in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of rate splitting for an NCJT as described herein. For example, the communications manager 1320 may include a TCI state manager 1325, a DMRS port manager 1330, an NCJT manager 1335, a capability manager 1340, a rate splitting manager 1345, or any combination thereof. Each of these components may communicate, directly or indirectly, with one another (e.g., via one or more buses).

The communications manager 1320 may support wireless communication at a TRP in accordance with examples as disclosed herein. The TCI state manager 1325 may be configured as or otherwise support a means for transmitting first signaling indicating a set of multiple TCI states for an NCJT from a set of multiple TRPs including the TRP. The DMRS port manager 1330 may be configured as or otherwise support a means for transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The NCJT manager 1335 may be configured as or otherwise support a means for transmitting the NCJT in accordance with the two or more TCI states.

In some examples, the capability manager 1340 may be configured as or otherwise support a means for receiving a capability message indicating a capability of a UE to receive the NCJT using the first set of DMRS ports and the second set of DMRS ports, where the NCJT is scheduled using the first set of DMRS ports and the second set of DMRS ports based on the capability of the UE.

In some examples, the capability message indicates a capability of the UE to support one or more codeword mapping schemes for the first set of DMRS ports and the second set of DMRS ports.

In some examples, the NCJT includes at least a first portion including first information common to a set of multiple UEs and a second portion including information specific to a UE of the set of multiple UEs. In some examples, the first set of DMRS ports corresponds to the first portion of the NCJT and the second set of DMRS ports corresponds to the second portion of the NCJT.

In some examples, one or more fields of the second signaling indicate the first set of DMRS ports and the second set of DMRS ports.

In some examples, the second signaling indicates a respective quantity of DMRS ports in each of the first set of DMRS ports and the second set of DMRS ports.

In some examples, the DMRS port manager 1330 may be configured as or otherwise support a means for mapping the first set of DMRS ports and the second set of DMRS ports to a single codeword, where the second signaling indicates one or more parameters associated with the single codeword.

In some examples, the DMRS port manager 1330 may be configured as or otherwise support a means for mapping the first set of DMRS ports to a first codeword. In some examples, the DMRS port manager 1330 may be configured as or otherwise support a means for mapping the second set of DMRS ports to a second codeword, where the second signaling indicates a first set of parameters associated with the first codeword and a second set of parameters associated with the second codeword.

In some examples, the DMRS port manager 1330 may be configured as or otherwise support a means for mapping the second set of DMRS ports to a codeword, where the second signaling indicates a set of parameters associated with the codeword. In some examples, the DMRS port manager 1330 may be configured as or otherwise support a means for refraining from mapping the first set of DMRS ports to the codeword.

In some examples, the second signaling further schedules the NCJT using a third set of DMRS ports associated with a second TCI state of the two or more TCI states.

In some examples, the NCJT includes at least a first portion including first information common to a set of multiple UEs and a second portion including information specific to a UE of the set of multiple UEs. In some examples, the first set of DMRS ports corresponds to the first portion of the NCJT, the second set of DMRS ports corresponds to the second portion of the NCJT, and the third set of DMRS ports correspond to the second portion of the NCJT.

In some examples, the DMRS port manager 1330 may be configured as or otherwise support a means for mapping the first set of DMRS ports to a first codeword, the second set of DMRS ports to a second codeword, and the third set of DMRS ports to the second codeword, where the second signaling indicates a first set of parameters associated with the first codeword and a second set of parameters associated with the second codeword.

In some examples, the DMRS port manager 1330 may be configured as or otherwise support a means for mapping the first set of DMRS ports to a first codeword, the second set of DMRS ports to a second codeword, and the third set of DMRS ports to a third codeword, where the second signaling indicates a first set of parameters associated with the first codeword, a second set of parameters associated with the second codeword, and a third set of parameters associated with the third codeword.

Additionally, or alternatively, the communications manager 1320 may support wireless communication at a TRP in accordance with examples as disclosed herein. In some examples, the TCI state manager 1325 may be configured as or otherwise support a means for transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs. In some examples, the DMRS port manager 1330 may be configured as or otherwise support a means for transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. In some examples, the NCJT manager 1335 may be configured as or otherwise support a means for transmitting the NCJT in accordance with the first TCI state and the second TCI state.

In some examples, the capability manager 1340 may be configured as or otherwise support a means for receiving a capability message indicating a capability of the UE to receive the NCJT using the first set of DMRS ports, the second set of DMRS ports, the third set of DMRS ports, and the fourth set of DMRS ports, where the NCJT is scheduled using the first set of DMRS ports, the second set of DMRS ports, the third set of DMRS ports, and the fourth set of DMRS ports based on the capability of the UE.

In some examples, the capability message indicates a capability of the UE to support one or more codeword mapping schemes for the first set of DMRS ports, the second set of DMRS ports, the third set of DMRS ports, the fourth set of DMRS ports, or any combination thereof.

In some examples, the first set of DMRS ports and the third set of DMRS ports map to a first code division multiplexing group. In some examples, the second set of DMRS ports and the fourth set of DMRS ports map to a second code division multiplexing group different from the first code division multiplexing group based on the mapping of a set of DMRS ports to a respective code division multiplexing group corresponding to a respective TCI state associated with the set of DMRS ports.

In some examples, the first set of DMRS ports and the second set of DMRS ports map to a first code division multiplexing group. In some examples, the third set of DMRS ports and the fourth set of DMRS ports map to a second code division multiplexing group based on the mapping of a set of DMRS ports to a respective code division multiplexing group corresponding to a respective portion of the NCJT.

In some examples, the first set of DMRS ports map to a first code division multiplexing group. In some examples, the second set of DMRS ports map to a second code division multiplexing group. In some examples, the third set of DMRS ports map to a third code division multiplexing group. In some examples, the fourth set of DMRS ports map to a fourth code division multiplexing group based on the mapping of a set of DMRS ports to a respective code division multiplexing group being on a per set of DMRS ports basis.

In some examples, one or more fields of the second signaling indicate the first set of DMRS ports, the second set of DMRS ports, the third set of DMRS ports, and the fourth set of DMRS ports.

In some examples, the second signaling indicates a respective quantity of DMRS ports in each of the first set of DMRS ports, the second set of DMRS ports, the third set of DMRS ports, and the fourth set of DMRS ports.

In some examples, the DMRS port manager 1330 may be configured as or otherwise support a means for mapping the first set of DMRS ports, the second set of DMRS ports, the third set of DMRS ports, and the fourth set of DMRS ports to a single codeword, where the second signaling indicates one or more parameters associated with the single codeword.

In some examples, the DMRS port manager 1330 may be configured as or otherwise support a means for mapping the first set of DMRS ports and the second set of DMRS ports to a first codeword. In some examples, the DMRS port manager 1330 may be configured as or otherwise support a means for mapping the third set of DMRS ports and the fourth set of DMRS ports to a second codeword based on a set of DMRS ports mapping to a respective codeword corresponding to a respective portion of the NCJT, where the second signaling indicates a first set of parameters associated with the first codeword and a second set of parameters associated with the second codeword.

In some examples, the DMRS port manager 1330 may be configured as or otherwise support a means for mapping the first set of DMRS ports and the third set of DMRS ports to a first codeword. In some examples, the DMRS port manager 1330 may be configured as or otherwise support a means for mapping the second set of DMRS ports and the fourth set of DMRS ports to a second codeword based on a set of DMRS ports mapping to a respective codeword corresponding to a respective TCI state, where the second signaling indicates a first set of parameters associated with the first codeword and a second set of parameters associated with the second codeword.

In some examples, the DMRS port manager 1330 may be configured as or otherwise support a means for mapping the first set of DMRS ports to a first codeword. In some examples, the DMRS port manager 1330 may be configured as or otherwise support a means for mapping the second set of DMRS ports to a second codeword. In some examples, the DMRS port manager 1330 may be configured as or otherwise support a means for mapping the third set of DMRS ports to a third codeword. In some examples, the DMRS port manager 1330 may be configured as or otherwise support a means for mapping the fourth set of DMRS ports to a fourth codeword, where the second signaling indicates a first set of parameters associated with the first codeword, a second set of parameters associated with the second codeword, a third set of parameters associated with the third codeword, and a fourth set of parameters associated with the fourth codeword.

In some examples, the DMRS port manager 1330 may be configured as or otherwise support a means for mapping the third set of DMRS ports and the fourth set of DMRS ports to one or more codewords, where the second signaling indicates respective sets of parameters associated with the one or more codewords. In some examples, the DMRS port manager 1330 may be configured as or otherwise support a means for refraining from mapping the first set of DMRS ports, the second set of DMRS ports, or both to the one or more codewords.

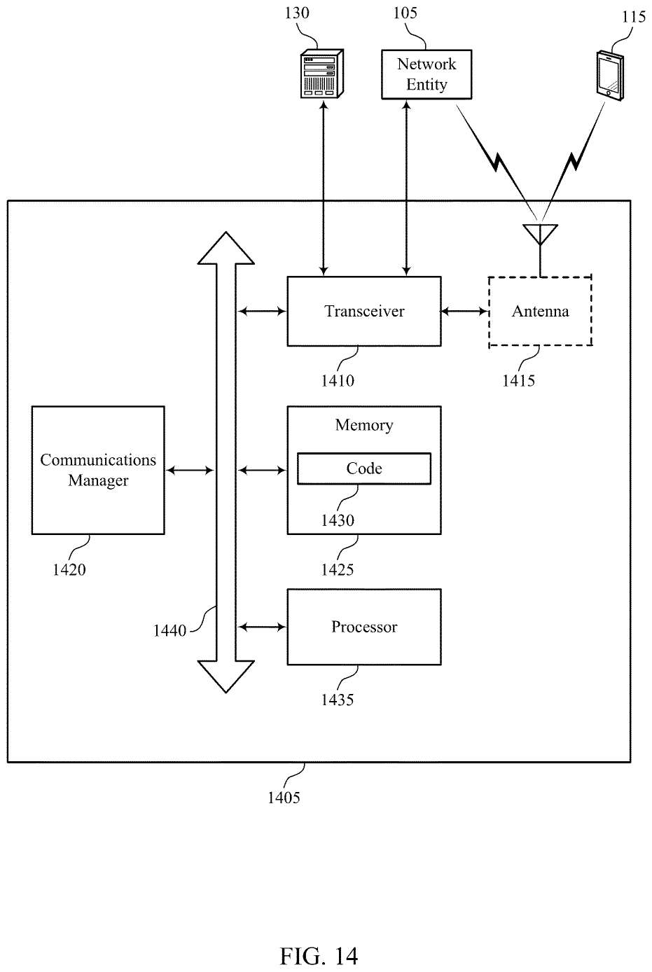

FIG. 14 illustrates a diagram of a system 1400 including a device 1405 that supports rate splitting for an NCJT in accordance with one or more aspects of the present disclosure. The device 1405 may be an example of or include the components of a device 1105, a device 1205, or an TRP as described herein. The device 1405 may include components for bi-directional voice and data communications including components for transmitting and receiving communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting rate splitting for an NCJT). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a TRP in accordance with examples as disclosed herein. For example, the communications manager 1420 may be configured as or otherwise support a means for transmitting first signaling indicating a set of multiple TCI states for an NCJT from a set of multiple TRPs including the TRP. The communications manager 1420 may be configured as or otherwise support a means for transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The communications manager 1420 may be configured as or otherwise support a means for transmitting the NCJT in accordance with the two or more TCI states.

Additionally, or alternatively, the communications manager 1420 may support wireless communication at a TRP in accordance with examples as disclosed herein. For example, the communications manager 1420 may be configured as or otherwise support a means for transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs. The communications manager 1420 may be configured as or otherwise support a means for transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The communications manager 1420 may be configured as or otherwise support a means for transmitting the NCJT in accordance with the first TCI state and the second TCI state.

By including or configuring the communications manager 1420 in accordance with examples as described herein, the device 1405 may support techniques for one or more TRPs to transmit control signaling indicating DMRS port information for a UE 115 to use for receiving an NCJT, which may provide for improved communication reliability, reduced latency, improved user experience related to reduced processing, reduced power consumption, more efficient utilization of communication resources, improved coordination between devices, longer battery life, improved utilization of processing capability, or the like.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of rate splitting for an NCJT as described herein, or the processor 1435 and the memory 1425 may be otherwise configured to perform or support such operations.

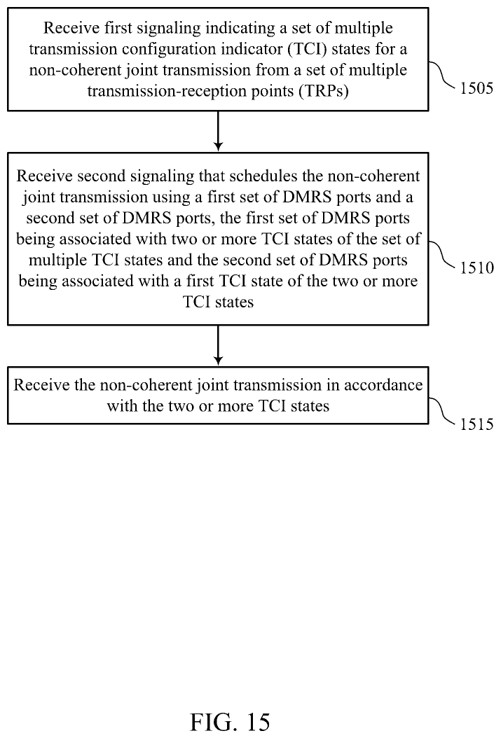

FIG. 15 illustrates a flowchart showing a method 1500 that supports rate splitting for an NCJT in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving first signaling indicating a set of multiple TCI states for an NCJT from a set of multiple TRPs. The operations of 1505 may be performed in accordance with examples as disclosed herein. In some examples, aspects of the operations of 1505 may be performed by a TCI state component 925 as described with reference to FIG. 9.

At 1510, the method may include receiving second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The operations of 1510 may be performed in accordance with examples as disclosed herein. In some examples, aspects of the operations of 1510 may be performed by a DMRS port component 930 as described with reference to FIG. 9.

At 1515, the method may include receiving the NCJT in accordance with the two or more TCI states. The operations of 1515 may be performed in accordance with examples as disclosed herein. In some examples, aspects of the operations of 1515 may be performed by an NCJT component 935 as described with reference to FIG. 9.

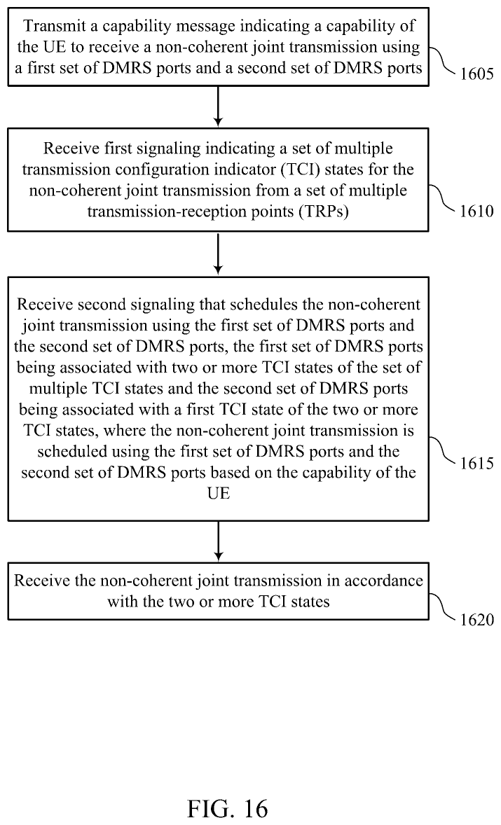

FIG. 16 illustrates a flowchart showing a method 1600 that supports rate splitting for an NCJT in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message indicating a capability of the UE to receive an NCJT using a first set of DMRS ports and a second set of DMRS ports. The operations of 1605 may be performed in accordance with examples as disclosed herein. In some examples, aspects of the operations of 1605 may be performed by a capability component 940 as described with reference to FIG. 9.

At 1610, the method may include receiving first signaling indicating a set of multiple TCI states for the NCJT from a set of multiple TRPs. The operations of 1610 may be performed in accordance with examples as disclosed herein. In some examples, aspects of the operations of 1610 may be performed by a TCI state component 925 as described with reference to FIG. 9.

At 1615, the method may include receiving second signaling that schedules the NCJT using the first set of DMRS ports and the second set of DMRS ports, the first set of DMRS ports being associated with two or more TCI states of the set of multiple TCI states and the second set of DMRS ports being associated with a first TCI state of the two or more TCI states, where the NCJT is scheduled using the first set of DMRS ports and the second set of DMRS ports based on the capability of the UE. The operations of 1615 may be performed in accordance with examples as disclosed herein. In some examples, aspects of the operations of 1615 may be performed by a DMRS port component 930 as described with reference to FIG. 9.

At 1620, the method may include receiving the NCJT in accordance with the two or more TCI states. The operations of 1620 may be performed in accordance with examples as disclosed herein. In some examples, aspects of the operations of 1620 may be performed by an NCJT component 935 as described with reference to FIG. 9.

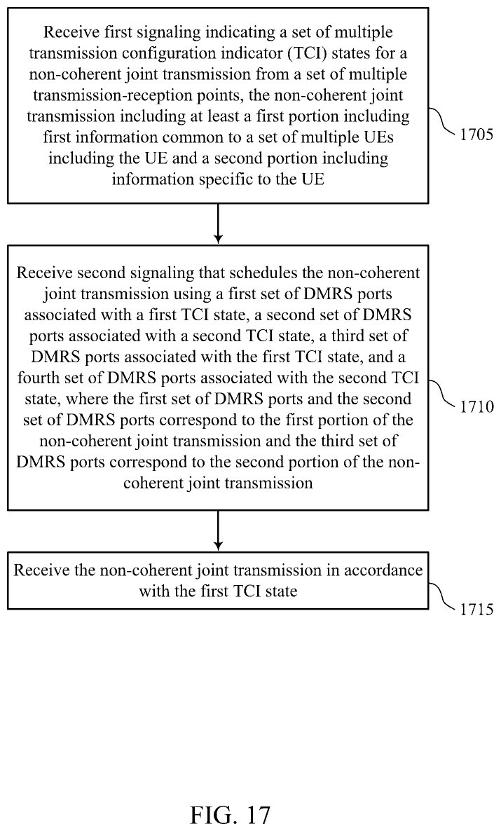

FIG. 17 illustrates a flowchart showing a method 1700 that supports rate splitting for an NCJT in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving first signaling indicating a set of multiple TCI states for an NCJT from a set of multiple TRPs, the NCJT including at least a first portion including first information common to a set of multiple UEs including the UE and a second portion including information specific to the UE. The operations of 1705 may be performed in accordance with examples as disclosed herein. In some examples, aspects of the operations of 1705 may be performed by a TCI state component 925 as described with reference to FIG. 9.

At 1710, the method may include receiving second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The operations of 1710 may be performed in accordance with examples as disclosed herein. In some examples, aspects of the operations of 1710 may be performed by a DMRS port component 930 as described with reference to FIG. 9.

At 1715, the method may include receiving the NCJT in accordance with the first TCI state. The operations of 1715 may be performed in accordance with examples as disclosed herein. In some examples, aspects of the operations of 1715 may be performed by an NCJT component 935 as described with reference to FIG. 9.

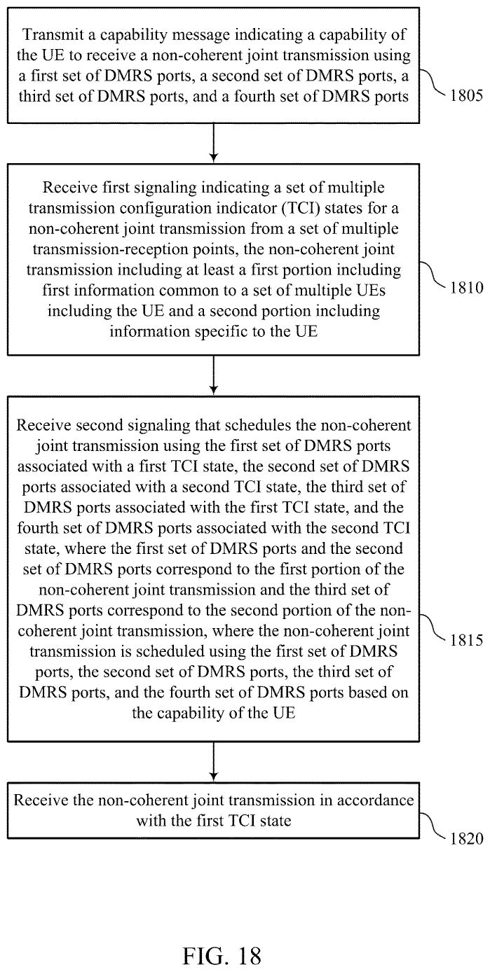

FIG. 18 illustrates a flowchart showing a method 1800 that supports rate splitting for an NCJT in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting a capability message indicating a capability of the UE to receive an NCJT using a first set of DMRS ports, a second set of DMRS ports, a third set of DMRS ports, and a fourth set of DMRS ports. The operations of 1805 may be performed in accordance with examples as disclosed herein. In some examples, aspects of the operations of 1805 may be performed by a capability component 940 as described with reference to FIG. 9.

At 1810, the method may include receiving first signaling indicating a set of multiple TCI states for the NCJT from a set of multiple TRPs, the NCJT including at least a first portion including first information common to a set of multiple UEs including the UE and a second portion including information specific to the UE. The operations of 1810 may be performed in accordance with examples as disclosed herein. In some examples, aspects of the operations of 1810 may be performed by a TCI state component 925 as described with reference to FIG. 9.

At 1815, the method may include receiving second signaling that schedules the NCJT using the first set of DMRS ports associated with a first TCI state, the second set of DMRS ports associated with a second TCI state, the third set of DMRS ports associated with the first TCI state, and the fourth set of DMRS ports associated with the second TCI state, where the first set of DMRS ports and the second set of DMRS ports correspond to the first portion of the NCJT and the third set of DMRS ports correspond to the second portion of the NCJT, where the NCJT is scheduled using the first set of DMRS ports, the second set of DMRS ports, the third set of DMRS ports, and the fourth set of DMRS ports based on the capability of the UE. The operations of 1815 may be performed in accordance with examples as disclosed herein. In some examples, aspects of the operations of 1815 may be performed by a DMRS port component 930 as described with reference to FIG. 9.

At 1820, the method may include receiving the NCJT in accordance with the first TCI state. The operations of 1820 may be performed in accordance with examples as disclosed herein. In some examples, aspects of the operations of 1820 may be performed by an NCJT component 935 as described with reference to FIG. 9.

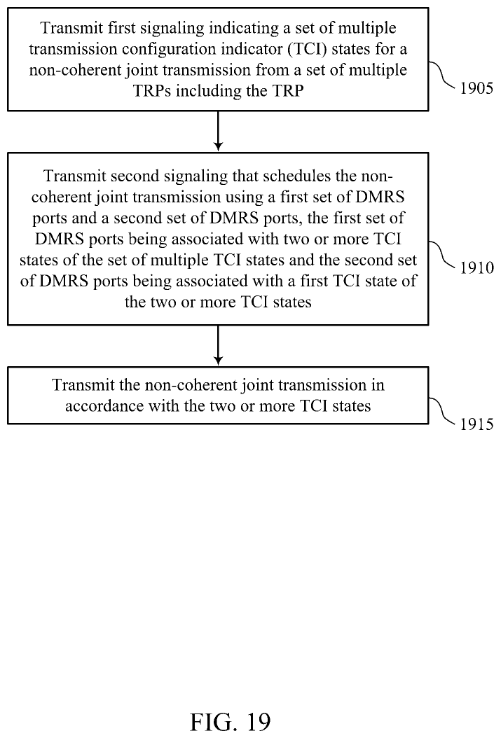

FIG. 19 illustrates a flowchart showing a method 1900 that supports rate splitting for an NCJT in accordance with one or more aspects of the present disclosure. The operations of the method 1900 may be implemented by an TRP or its components as described herein. For example, the operations of the method 1900 may be performed by an TRP as described with reference to FIGS. 1 through 6 and 11 through 14. In some examples, an TRP may execute a set of instructions to control the functional elements of the TRP to perform the described functions. Additionally, or alternatively, the TRP may perform aspects of the described functions using special-purpose hardware.

At 1905, the method may include transmitting first signaling indicating a set of multiple TCI states for an NCJT from a set of multiple TRPs including the TRP. The operations of 1905 may be performed in accordance with examples as disclosed herein. In some examples, aspects of the operations of 1905 may be performed by a TCI state manager 1325 as described with reference to FIG. 13.

At 1910, the method may include transmitting second signaling that schedules the NCJT using a first set of DMRS ports and a second set of DMRS ports, the first set of DMRS ports being associated with two or more TCI states of the set of multiple TCI states and the second set of DMRS ports being associated with a first TCI state of the two or more TCI states. The operations of 1910 may be performed in accordance with examples as disclosed herein. In some examples, aspects of the operations of 1910 may be performed by a DMRS port manager 1330 as described with reference to FIG. 13.

At 1915, the method may include transmitting the NCJT in accordance with the two or more TCI states. The operations of 1915 may be performed in accordance with examples as disclosed herein. In some examples, aspects of the operations of 1915 may be performed by an NCJT manager 1335 as described with reference to FIG. 13.

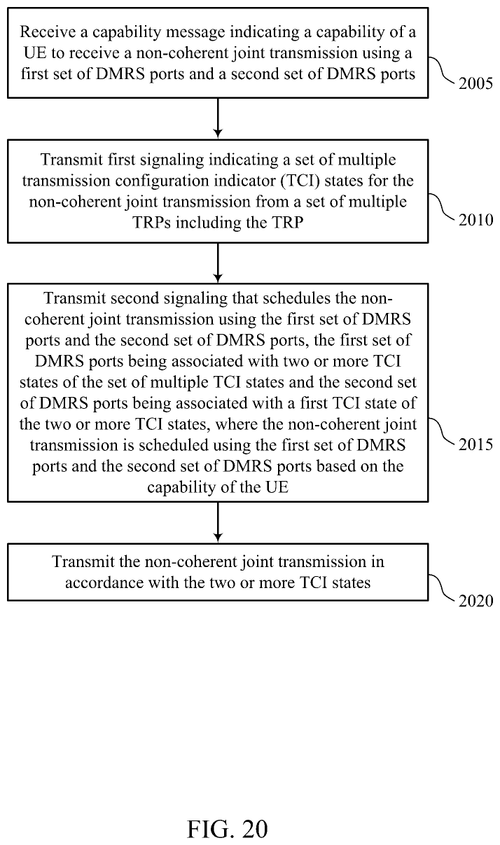

FIG. 20 illustrates a flowchart showing a method 2000 that supports rate splitting for an NCJT in accordance with one or more aspects of the present disclosure. The operations of the method 2000 may be implemented by an TRP or its components as described herein. For example, the operations of the method 2000 may be performed by an TRP as described with reference to FIGS. 1 through 6 and 11 through 14. In some examples, an TRP may execute a set of instructions to control the functional elements of the TRP to perform the described functions. Additionally, or alternatively, the TRP may perform aspects of the described functions using special-purpose hardware.

At 2005, the method may include receiving a capability message indicating a capability of a UE to receive an NCJT using a first set of DMRS ports and a second set of DMRS ports. The operations of 2005 may be performed in accordance with examples as disclosed herein. In some examples, aspects of the operations of 2005 may be performed by a capability manager 1340 as described with reference to FIG. 13.

At 2010, the method may include transmitting first signaling indicating a set of multiple TCI states for the NCJT from a set of multiple TRPs including the TRP. The operations of 2010 may be performed in accordance with examples as disclosed herein. In some examples, aspects of the operations of 2010 may be performed by a TCI state manager 1325 as described with reference to FIG. 13.

At 2015, the method may include transmitting second signaling that schedules the NCJT using the first set of DMRS ports and the second set of DMRS ports, the first set of DMRS ports being associated with two or more TCI states of the set of multiple TCI states and the second set of DMRS ports being associated with a first TCI state of the two or more TCI states, where the NCJT is scheduled using the first set of DMRS ports and the second set of DMRS ports based on the capability of the UE. The operations of 2015 may be performed in accordance with examples as disclosed herein. In some examples, aspects of the operations of 2015 may be performed by a DMRS port manager 1330 as described with reference to FIG. 13.

At 2020, the method may include transmitting the NCJT in accordance with the two or more TCI states. The operations of 2020 may be performed in accordance with examples as disclosed herein. In some examples, aspects of the operations of 2020 may be performed by an NCJT manager 1335 as described with reference to FIG. 13.

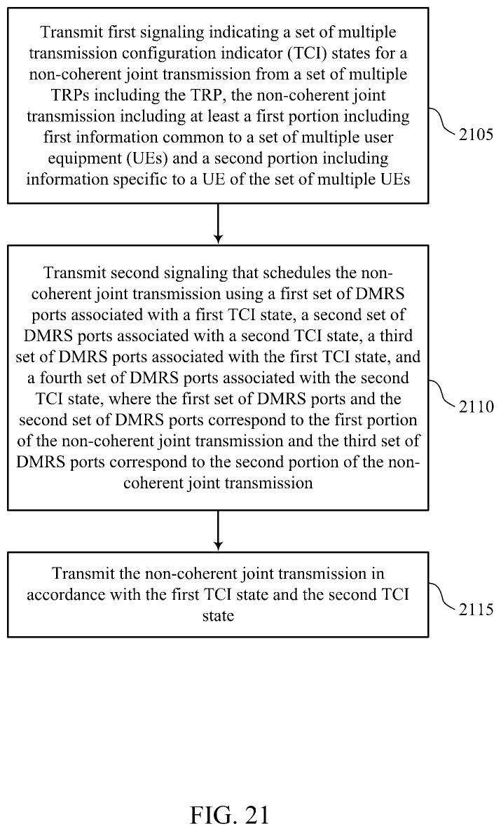

FIG. 21 illustrates a flowchart showing a method 2100 that supports rate splitting for an NCJT in accordance with one or more aspects of the present disclosure. The operations of the method 2100 may be implemented by an TRP or its components as described herein. For example, the operations of the method 2100 may be performed by an TRP as described with reference to FIGS. 1 through 6 and 11 through 14. In some examples, an TRP may execute a set of instructions to control the functional elements of the TRP to perform the described functions. Additionally, or alternatively, the TRP may perform aspects of the described functions using special-purpose hardware.

At 2105, the method may include transmitting first signaling indicating a set of multiple TCI states for an NCJT from a set of multiple TRPs including the TRP, the NCJT including at least a first portion including first information common to a set of multiple UEs and a second portion including information specific to a UE of the set of multiple UEs. The operations of 2105 may be performed in accordance with examples as disclosed herein. In some examples, aspects of the operations of 2105 may be performed by a TCI state manager 1325 as described with reference to FIG. 13.

At 2110, the method may include transmitting second signaling that schedules the NCJT using a first set of DMRS ports associated with a first TCI state, a second set of DMRS ports associated with a second TCI state, a third set of DMRS ports associated with the first TCI state, and a fourth set of DMRS ports associated with the second TCI state, where the first set of DMRS ports and the second set of DMRS ports correspond to the first portion of the NCJT and the third set of DMRS ports correspond to the second portion of the NCJT. The operations of 2110 may be performed in accordance with examples as disclosed herein. In some examples, aspects of the operations of 2110 may be performed by a DMRS port manager 1330 as described with reference to FIG. 13.

At 2115, the method may include transmitting the NCJT in accordance with the first TCI state and the second TCI state. The operations of 2115 may be performed in accordance with examples as disclosed herein. In some examples, aspects of the operations of 2115 may be performed by an NCJT manager 1335 as described with reference to FIG. 13.

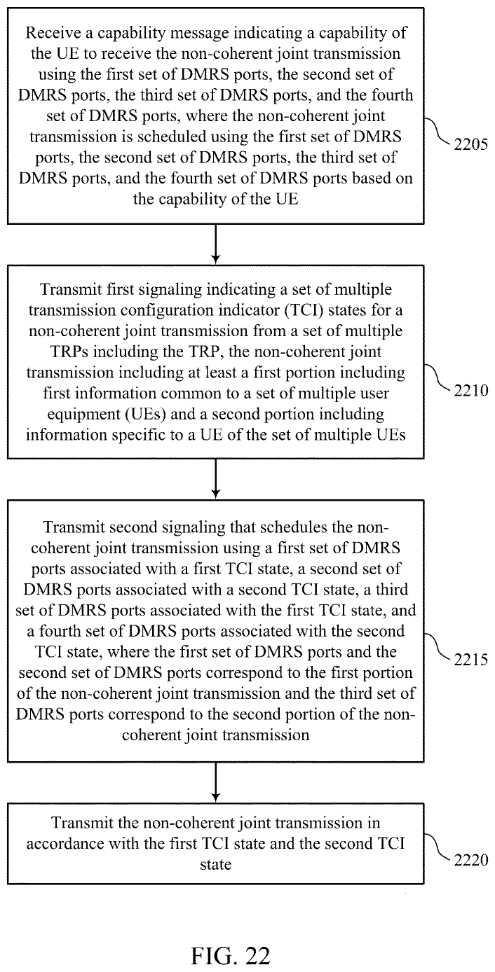

FIG. 22 illustrates a flowchart showing a method 2200 that supports rate splitting for an NCJT in accordance with one or more aspects of the present disclosure. The operations of the method 2200 may be implemented by an TRP or its components as described herein. For example, the operations of the method 2200 may be performed by an TRP as described with reference to FIGS. 1 through 6 and 11 through 14. In some examples, an TRP may execute a set of instructions to control the functional elements of the TRP to perform the described functions. Additionally, or alternatively, the TRP may perform aspects of the described functions using special-purpose hardware.

At 2205, the method may include receiving a capability message indicating a capability of the UE to receive an NCJT using a first set of DMRS ports, a second set of DMRS ports, a third set of DMRS ports, and a fourth set of DMRS ports. The operations of 2205 may be performed in accordance with examples as disclosed herein. In some examples, aspects of the operations of 2205 may be performed by a capability manager 1340 as described with reference to FIG. 13.

At 2210, the method may include transmitting first signaling indicating a set of multiple TCI states for the NCJT from a set of multiple TRPs including the TRP, the NCJT including at least a first portion including first information common to a set of multiple UEs and a second portion including information specific to a UE of the set of multiple UEs. The operations of 2210 may be performed in accordance with examples as disclosed herein. In some examples, aspects of the operations of 2210 may be performed by a TCI state manager 1325 as described with reference to FIG. 13.

At 2215, the method may include transmitting second signaling that schedules the NCJT using the first set of DMRS ports associated with a first TCI state, the second set of DMRS ports associated with a second TCI state, the third set of DMRS ports associated with the first TCI state, and the fourth set of DMRS ports associated with the second TCI state, where the first set of DMRS ports and the second set of DMRS ports correspond to the first portion of the NCJT and the third set of DMRS ports correspond to the second portion of the NCJT, where the NCJT is scheduled using the first set of DMRS ports, the second set of DMRS ports, the third set of DMRS ports, and the fourth set of DMRS ports based on the capability of the UE. The operations of 2215 may be performed in accordance with examples as disclosed herein. In some examples, aspects of the operations of 2215 may be performed by a DMRS port manager 1330 as described with reference to FIG. 13.

At 2220, the method may include transmitting the NCJT in accordance with the first TCI state and the second TCI state. The operations of 2220 may be performed in accordance with examples as disclosed herein. In some examples, aspects of the operations of 2220 may be performed by an NCJT manager 1335 as described with reference to FIG. 13.

The following provides an overview of aspects of the present disclosure:
Aspect 1: A method for wireless communication at a UE, comprising: receiving first signaling indicating a plurality of TCI states for a non-coherent joint transmission from a plurality of TRPs; receiving second signaling that schedules the non-coherent joint transmission using a first set of DMRS ports and a second set of DMRS ports, the first set of DMRS ports being associated with two or more TCI states of the plurality of TCI states and the second set of DMRS ports being associated with a first TCI state of the two or more TCI states; and receiving the non-coherent joint transmission in accordance with the two or more TCI states.
Aspect 2: The method of aspect 1, further comprising: transmitting a capability message indicating a capability of the UE to receive the non-coherent joint transmission using the first set of DMRS ports and the second set of DMRS ports, wherein the non-coherent joint transmission is scheduled using the first set of DMRS ports and the second set of DMRS ports based at least in part on the capability of the UE.
Aspect 3: The method of aspect 2, wherein the capability message indicates a capability of the UE to support one or more codeword mapping schemes for the first set of DMRS ports and the second set of DMRS ports.
Aspect 4: The method of any of aspects 1 through 3, wherein the non-coherent joint transmission comprises at least a first portion including first information common to a plurality of UEs comprising the UE and a second portion including information specific to the UE; and the first set of DMRS ports corresponds to the first portion of the non-coherent joint transmission and the second set of DMRS ports corresponds to the second portion of the non-coherent joint transmission.
Aspect 5: The method of any of aspects 1 through 4, further comprising: determining, in accordance with a mapping between the first set of DMRS ports and a first code division multiplexing group and between the second set of DMRS ports and a second code division multiplexing group, the first set of DMRS ports based at least in part on the first code division multiplexing group and the second set of DMRS ports based at least in part on the second code division multiplexing group different from the first code division multiplexing group.
Aspect 6: The method of any of aspects 1 through 5, wherein one or more fields of the second signaling indicate the first set of DMRS ports and the second set of DMRS ports.
Aspect 7: The method of any of aspects 1 through 6, further comprising: determining the first set of DMRS ports and the second set of DMRS ports based at least in part on an order of the first set of DMRS ports and the second set of DMRS ports and a respective quantity of DMRS ports in each of the first set of DMRS ports and the second set of DMRS ports, wherein the second signaling indicates the respective quantity of DMRS ports in each of the first set of DMRS ports and the second set of DMRS ports.
Aspect 8: The method of any of aspects 1 through 7, wherein a single codeword corresponds to the first set of DMRS ports and the second set of DMRS ports; and the second signaling indicates one or more parameters associated with the single codeword.
Aspect 9: The method of any of aspects 1 through 7, wherein a first codeword corresponds to the first set of DMRS ports; a second codeword corresponds to the second set of DMRS ports; and the second signaling indicates a first set of parameters associated with the first codeword and a second set of parameters associated with the second codeword.
Aspect 10: The method of any of aspects 1 through 7, wherein the first set of DMRS ports excludes a mapping to a codeword; the codeword corresponds to the second set of DMRS ports; and the second signaling indicates a set of parameters associated with the codeword.
Aspect 11: The method of any of aspects 1 through 10, wherein the second signaling further schedules the non-coherent joint transmission using a third set of DMRS ports associated with a second TCI state of the two or more TCI states.
Aspect 12: The method of aspect 11, wherein the non-coherent joint transmission comprises at least a first portion including first information common to a plurality of UEs comprising the UE and a second portion including information specific to the UE; and the first set of DMRS ports corresponds to the first portion of the non-coherent joint transmission, the second set of DMRS ports corresponds to the second portion of the non-coherent joint transmission, and the third set of DMRS ports correspond to the second portion of the non-coherent joint transmission.
Aspect 13: The method of any of aspects 11 through 12, wherein a first codeword corresponds to the first set of DMRS ports; a second codeword corresponds to the second set of DMRS ports and the third set of DMRS ports; and the second signaling indicates a first set of parameters associated with the first codeword and a second set of parameters associated with the second codeword.
Aspect 14: The method of any of aspects 11 through 12, wherein a first codeword corresponds to the first set of DMRS ports; a second codeword corresponds to the second set of DMRS ports; a third codeword corresponds to the third set of DMRS ports; and the second signaling indicates a first set of parameters associated with the first codeword, a second set of parameters associated with the second codeword, and a third set of parameters associated with the third codeword.
Aspect 15: A method for wireless communication at a UE, comprising: receiving first signaling indicating a plurality of transmission configuration indicator (TCI) states for a non-coherent joint transmission from a plurality of transmission-reception points, the non-coherent joint transmission comprising at least a first portion including first information common to a plurality of UEs comprising the UE and a second portion including information specific to the UE; receiving second signaling that schedules the non-coherent joint transmission using a first set of DMRS ports associated with a first TCI state, a second set of DMRS ports associated with a second TCI state, a third set of DMRS ports associated with the first TCI state, and a fourth set of DMRS ports associated with the second TCI state, wherein the first set of DMRS ports and the second set of DMRS ports correspond to the first portion of the non-coherent joint transmission and the third set of DMRS ports correspond to the second portion of the non-coherent joint transmission; and receiving the non-coherent joint transmission in accordance with the first TCI state.
Aspect 16: The method of aspect 15, further comprising: transmitting a capability message indicating a capability of the UE to receive the non-coherent joint transmission using the first set of DMRS ports, the second set of DMRS ports, the third set of DMRS ports, and the fourth set of DMRS ports, wherein the non-coherent joint transmission is scheduled using the first set of DMRS ports, the second set of DMRS ports, the third set of DMRS ports, and the fourth set of DMRS ports based at least in part on the capability of the UE.
Aspect 17: The method of aspect 16, wherein the capability message indicates a capability of the UE to support one or more codeword mapping schemes for the first set of DMRS ports, the second set of DMRS ports, the third set of DMRS ports, the fourth set of DMRS ports, or any combination thereof.
Aspect 18: The method of any of aspects 15 through 17, further comprising: determining the first set of DMRS ports, the second set of DMRS ports, the third set of DMRS ports, and the fourth set of DMRS ports based at least in part on one or more code division multiplexing groups and in accordance with a mapping between the first set of DMRS ports and the one or more code division multiplexing groups, the second set of DMRS ports and the one or more code division multiplexing groups, the third set of DMRS ports and the one or more code division multiplexing groups, and the fourth set of DMRS ports and the one or more code division multiplexing groups.
Aspect 19: The method of aspect 18, wherein the first set of DMRS ports and the second set of DMRS ports map to a first code division multiplexing group; and the third set of DMRS ports and the fourth set of DMRS ports map to a second code division multiplexing group based at least in part on the mapping of a set of DMRS ports to a respective code division multiplexing group corresponding to a respective portion of the non-coherent joint transmission.
Aspect 20: The method of aspect 18, wherein the first set of DMRS ports and the third set of DMRS ports map to a first code division multiplexing group; and the second set of DMRS ports and the fourth set of DMRS ports map to a second code division multiplexing group different from the first code division multiplexing group based at least in part on the mapping of a set of DMRS ports to a respective code division multiplexing group corresponding to a respective TCI state associated with the set of DMRS ports.
Aspect 21: The method of aspect 18, wherein the first set of DMRS ports map to a first code division multiplexing group; the second set of DMRS ports map to a second code division multiplexing group; the third set of DMRS ports map to a third code division multiplexing group; and the fourth set of DMRS ports map to a fourth code division multiplexing group based at least in part on the mapping of a set of DMRS ports to a respective code division multiplexing group being on a per set of DMRS ports basis.
Aspect 22: The method of any of aspects 15 through 21, wherein one or more fields of the second signaling indicate the first set of DMRS ports, the second set of DMRS ports, the third set of DMRS ports, and the fourth set of DMRS ports.
Aspect 23: The method of any of aspects 15 through 22, further comprising: determining the first set of DMRS ports, the second set of DMRS ports, the third set of DMRS ports, and the fourth set of DMRS ports based at least in part on the second signaling indicating a respective quantity of DMRS ports in each of the first set of DMRS ports, the second set of DMRS ports, the third set of DMRS ports, and the fourth set of DMRS ports.
Aspect 24: The method of any of aspects 15 through 23, wherein a single codeword corresponds to the first set of DMRS ports, the second set of DMRS ports, the third set of DMRS ports, and the fourth set of DMRS ports; and the second signaling indicates one or more parameters associated with the single codeword.
Aspect 25: The method of any of aspects 15 through 23, wherein a first codeword corresponds to the first set of DMRS ports and the second set of DMRS ports; a second codeword corresponding to the third set of DMRS ports and the fourth set of DMRS ports based at least in part on a mapping of a set of DMRS ports to a respective codeword corresponding to a respective portion of the non-coherent joint transmission; and the second signaling indicates a first set of parameters associated with the first codeword and a second set of parameters associated with the second codeword.
Aspect 26: The method of any of aspects 15 through 23, wherein a first codeword corresponds to the first set of DMRS ports and the third set of DMRS ports; a second codeword corresponding to the second set of DMRS ports and the fourth set of DMRS ports based at least in part on a mapping of a set of DMRS ports to a respective codeword corresponding to a respective TCI state; and the second signaling indicates a first set of parameters associated with the first codeword and a second set of parameters associated with the second codeword.
Aspect 27: The method of any of aspects 15 through 23, wherein a first codeword corresponds to the first set of DMRS ports; a second codeword corresponds to the second set of DMRS ports; a third codeword corresponds to the third set of DMRS ports; a fourth codeword corresponds to the fourth set of DMRS ports; and the second signaling indicates a first set of parameters associated with the first codeword, a second set of parameters associated with the second codeword, a third set of parameters associated with the third codeword, and a fourth set of parameters associated with the fourth codeword.
Aspect 28: The method of any of aspects 15 through 23, wherein the first set of DMRS ports, the second set of DMRS ports, or both exclude a mapping to one or more codewords; the one or more codewords correspond to the third set of DMRS ports and the fourth set of DMRS ports; and the second signaling indicates respective sets of parameters associated with the one or more codewords.
Aspect 29: A method for wireless communication at a TRP, comprising: transmitting first signaling indicating a plurality of TCI states for a non-coherent joint transmission from a plurality of TRPs comprising the TRP; transmitting second signaling that schedules the non-coherent joint transmission using a first set of DMRS ports and a second set of DMRS ports, the first set of DMRS ports being associated with two or more TCI states of the plurality of TCI states and the second set of DMRS ports being associated with a first TCI state of the two or more TCI states; and transmitting the non-coherent joint transmission in accordance with the two or more TCI states.
Aspect 30: The method of aspect 29, further comprising: receiving a capability message indicating a capability of a UE to receive the non-coherent joint transmission using the first set of DMRS ports and the second set of DMRS ports, wherein the non-coherent joint transmission is scheduled using the first set of DMRS ports and the second set of DMRS ports based at least in part on the capability of the UE.
Aspect 31: The method of aspect 30, wherein the capability message indicates a capability of the UE to support one or more codeword mapping schemes for the first set of DMRS ports and the second set of DMRS ports.
Aspect 32: The method of any of aspects 29 through 31, wherein the non-coherent joint transmission comprises at least a first portion including first information common to a plurality of UEs and a second portion including information specific to a UE of the plurality of UEs; and the first set of DMRS ports corresponds to the first portion of the non-coherent joint transmission and the second set of DMRS ports corresponds to the second portion of the non-coherent joint transmission.
Aspect 33: The method of any of aspects 29 through 32, wherein one or more fields of the second signaling indicate the first set of DMRS ports and the second set of DMRS ports.
Aspect 34: The method of any of aspects 29 through 33, wherein the second signaling indicates a respective quantity of DMRS ports in each of the first set of DMRS ports and the second set of DMRS ports.
Aspect 35: The method of any of aspects 29 through 34, further comprising: mapping the first set of DMRS ports and the second set of DMRS ports to a single codeword, wherein the second signaling indicates one or more parameters associated with the single codeword.
Aspect 36: The method of any of aspects 29 through 34, further comprising: mapping the first set of DMRS ports to a first codeword; and mapping the second set of DMRS ports to a second codeword, wherein the second signaling indicates a first set of parameters associated with the first codeword and a second set of parameters associated with the second codeword.
Aspect 37: The method of any of aspects 29 through 34, further comprising: mapping the second set of DMRS ports to a codeword, wherein the second signaling indicates a set of parameters associated with the codeword; and refraining from mapping the first set of DMRS ports to the codeword.
Aspect 38: The method of any of aspects 29 through 37, wherein the second signaling further schedules the non-coherent joint transmission using a third set of DMRS ports associated with a second TCI state of the two or more TCI states.
Aspect 39: The method of aspect 38, wherein the non-coherent joint transmission comprises at least a first portion including first information common to a plurality of UEs and a second portion including information specific to a UE of the plurality of UEs; and the first set of DMRS ports corresponds to the first portion of the non-coherent joint transmission, the second set of DMRS ports corresponds to the second portion of the non-coherent joint transmission, and the third set of DMRS ports correspond to the second portion of the non-coherent joint transmission.
Aspect 40: The method of any of aspects 38 through 39, further comprising: mapping the first set of DMRS ports to a first codeword, the second set of DMRS ports to a second codeword, and the third set of DMRS ports to the second codeword, wherein the second signaling indicates a first set of parameters associated with the first codeword and a second set of parameters associated with the second codeword.
Aspect 41: The method of any of aspects 38 through 39, further comprising: mapping the first set of DMRS ports to a first codeword, the second set of DMRS ports to a second codeword, and the third set of DMRS ports to a third codeword, wherein the second signaling indicates a first set of parameters associated with the first codeword, a second set of parameters associated with the second codeword, and a third set of parameters associated with the third codeword.
Aspect 42: A method for wireless communication at a TRP, comprising: transmitting first signaling indicating a plurality of TCI states for a non-coherent joint transmission from a plurality of TRPs comprising the TRP, the non-coherent joint transmission comprising at least a first portion including first information common to a plurality of UEs and a second portion including information specific to a UE of the plurality of UEs; transmitting second signaling that schedules the non-coherent joint transmission using a first set of DMRS ports associated with a first TCI state, a second set of DMRS ports associated with a second TCI state, a third set of DMRS ports associated with the first TCI state, and a fourth set of DMRS ports associated with the second TCI state, wherein the first set of DMRS ports and the second set of DMRS ports correspond to the first portion of the non-coherent joint transmission and the third set of DMRS ports correspond to the second portion of the non-coherent joint transmission; and transmitting the non-coherent joint transmission in accordance with the first TCI state and the second TCI state.
Aspect 43: The method of aspect 42, further comprising: receiving a capability message indicating a capability of the UE to receive the non-coherent joint transmission using the first set of DMRS ports, the second set of DMRS ports, the third set of DMRS ports, and the fourth set of DMRS ports, wherein the non-coherent joint transmission is scheduled using the first set of DMRS ports, the second set of DMRS ports, the third set of DMRS ports, and the fourth set of DMRS ports based at least in part on the capability of the UE.
Aspect 44: The method of aspect 43, wherein the capability message indicates a capability of the UE to support one or more codeword mapping schemes for the first set of DMRS ports, the second set of DMRS ports, the third set of DMRS ports, the fourth set of DMRS ports, or any combination thereof.
Aspect 45: The method of any of aspects 42 through 44, wherein the first set of DMRS ports and the third set of DMRS ports map to a first code division multiplexing group; and the second set of DMRS ports and the fourth set of DMRS ports map to a second code division multiplexing group different from the first code division multiplexing group based at least in part on the mapping of a set of DMRS ports to a respective code division multiplexing group corresponding to a respective TCI state associated with the set of DMRS ports.
Aspect 46: The method of any of aspects 42 through 44, wherein the first set of DMRS ports and the second set of DMRS ports map to a first code division multiplexing group; and the third set of DMRS ports and the fourth set of DMRS ports map to a second code division multiplexing group based at least in part on the mapping of a set of DMRS ports to a respective code division multiplexing group corresponding to a respective portion of the non-coherent joint transmission.
Aspect 47: The method of any of aspects 42 through 44, wherein the first set of DMRS ports map to a first code division multiplexing group; the second set of DMRS ports map to a second code division multiplexing group; the third set of DMRS ports map to a third code division multiplexing group; and the fourth set of DMRS ports map to a fourth code division multiplexing group based at least in part on the mapping of a set of DMRS ports to a respective code division multiplexing group being on a per set of DMRS ports basis.
Aspect 48: The method of any of aspects 42 through 47, wherein one or more fields of the second signaling indicate the first set of DMRS ports, the second set of DMRS ports, the third set of DMRS ports, and the fourth set of DMRS ports.
Aspect 49: The method of any of aspects 42 through 48, wherein the second signaling indicates a respective quantity of DMRS ports in each of the first set of DMRS ports, the second set of DMRS ports, the third set of DMRS ports, and the fourth set of DMRS ports.
Aspect 50: The method of any of aspects 42 through 49, further comprising: mapping the first set of DMRS ports, the second set of DMRS ports, the third set of DMRS ports, and the fourth set of DMRS ports to a single codeword, wherein the second signaling indicates one or more parameters associated with the single codeword.
Aspect 51: The method of any of aspects 42 through 49, further comprising: mapping the first set of DMRS ports and the second set of DMRS ports to a first codeword; and mapping the third set of DMRS ports and the fourth set of DMRS ports to a second codeword based at least in part on a set of DMRS ports mapping to a respective codeword corresponding to a respective portion of the non-coherent joint transmission, wherein the second signaling indicates a first set of parameters associated with the first codeword and a second set of parameters associated with the second codeword.
Aspect 52: The method of any of aspects 42 through 49, further comprising: mapping the first set of DMRS ports and the third set of DMRS ports to a first codeword; and mapping the second set of DMRS ports and the fourth set of DMRS ports to a second codeword based at least in part on a set of DMRS ports mapping to a respective codeword corresponding to a respective TCI state, wherein the second signaling indicates a first set of parameters associated with the first codeword and a second set of parameters associated with the second codeword.
Aspect 53: The method of any of aspects 42 through 49, further comprising: mapping the first set of DMRS ports to a first codeword; mapping the second set of DMRS ports to a second codeword; mapping the third set of DMRS ports to a third codeword; and mapping the fourth set of DMRS ports to a fourth codeword, wherein the second signaling indicates a first set of parameters associated with the first codeword, a second set of parameters associated with the second codeword, a third set of parameters associated with the third codeword, and a fourth set of parameters associated with the fourth codeword.
Aspect 54: The method of any of aspects 42 through 49, further comprising: mapping the third set of DMRS ports and the fourth set of DMRS ports to one or more codewords, wherein the second signaling indicates respective sets of parameters associated with the one or more codewords; and refraining from mapping the first set of DMRS ports, the second set of DMRS ports, or both to the one or more codewords.
Aspect 55: An apparatus for wireless communication at a UE, comprising a processor; memory coupled with the processor; and instructions stored in the memory and executable by the processor to cause the apparatus to perform a method of any of aspects 1 through 14.
Aspect 56: An apparatus for wireless communication at a UE, comprising at least one means for performing a method of any of aspects 1 through 14.
Aspect 57: A non-transitory computer-readable medium storing code for wireless communication at a UE, the code comprising instructions executable by a processor to perform a method of any of aspects 1 through 14.
Aspect 58: An apparatus for wireless communication at a UE, comprising a processor; memory coupled with the processor; and instructions stored in the memory and executable by the processor to cause the apparatus to perform a method of any of aspects 15 through 28.
Aspect 59: An apparatus for wireless communication at a UE, comprising at least one means for performing a method of any of aspects 15 through 28.
Aspect 60: A non-transitory computer-readable medium storing code for wireless communication at a UE, the code comprising instructions executable by a processor to perform a method of any of aspects 15 through 28.
Aspect 61: An apparatus for wireless communication at a TRP, comprising a processor; memory coupled with the processor; and instructions stored in the memory and executable by the processor to cause the apparatus to perform a method of any of aspects 29 through 41.
Aspect 62: An apparatus for wireless communication at a TRP, comprising at least one means for performing a method of any of aspects 29 through 41.
Aspect 63: A non-transitory computer-readable medium storing code for wireless communication at a TRP, the code comprising instructions executable by a processor to perform a method of any of aspects 29 through 41.
Aspect 64: An apparatus for wireless communication at a TRP, comprising a processor; memory coupled with the processor; and instructions stored in the memory and executable by the processor to cause the apparatus to perform a method of any of aspects 42 through 54.
Aspect 65: An apparatus for wireless communication at a TRP, comprising at least one means for performing a method of any of aspects 42 through 54.
Aspect 66: A non-transitory computer-readable medium storing code for wireless communication at a TRP, the code comprising instructions executable by a processor to perform a method of any of aspects 42 through 54.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive first signaling indicating a plurality of transmission configuration indicator (TCI) states for a non-coherent joint transmission from a plurality of transmission-reception points (TRPs);
receive second signaling that schedules the non-coherent joint transmission using a first set of demodulation reference signal (DMRS) ports and a second set of DMRS ports, the first set of DMRS ports being associated with two or more TCI states of the plurality of TCI states and the second set of DMRS ports being associated with a first TCI state of the two or more TCI states; and
receive the non-coherent joint transmission in accordance with the two or more TCI states.

2. The apparatus of claim 1, wherein the instructions are further executable by the processor to cause the apparatus to:
transmit a capability message indicating a capability of the UE to receive the non-coherent joint transmission using the first set of DMRS ports and the second set of DMRS ports, wherein the non-coherent joint transmission is scheduled using the first set of DMRS ports and the second set of DMRS ports based at least in part on the capability of the UE.

3. The apparatus of claim 2, wherein the capability message indicates a capability of the UE to support one or more codeword mapping schemes for the first set of DMRS ports and the second set of DMRS ports.

4. The apparatus of claim 1, wherein:
the non-coherent joint transmission comprises at least a first portion including first information common to a plurality of UEs comprising the UE and a second portion including information specific to the UE; and
the first set of DMRS ports corresponds to the first portion of the non-coherent joint transmission and the second set of DMRS ports corresponds to the second portion of the non-coherent joint transmission.

5. The apparatus of claim 1, wherein the instructions are further executable by the processor to cause the apparatus to:
determine, in accordance with a mapping between the first set of DMRS ports and a first code division multiplexing group and, the first set of DMRS ports based at least in part on the first code division multiplexing group; and
determine, in accordance with a mapping between the second set of DMRS ports and a second code division multiplexing group, the second set of DMRS ports based at least in part on the second code division multiplexing group, the second code division multiplexing group being different from the first code division multiplexing group.

6. The apparatus of claim 1, wherein one or more fields of the second signaling indicate the first set of DMRS ports and the second set of DMRS ports.

7. The apparatus of claim 1, wherein the instructions are further executable by the processor to cause the apparatus to:
determine the first set of DMRS ports and the second set of DMRS ports based at least in part on an order of the first set of DMRS ports and the second set of DMRS ports and a respective quantity of DMRS ports in each of the first set of DMRS ports and the second set of DMRS ports, wherein the second signaling indicates the respective quantity of DMRS ports in each of the first set of DMRS ports and the second set of DMRS ports.

8. The apparatus of claim 1, wherein:
a single codeword corresponds to the first set of DMRS ports and the second set of DMRS ports; and
the second signaling indicates one or more parameters associated with the single codeword.

9. The apparatus of claim 1, wherein:
a first codeword corresponds to the first set of DMRS ports;
a second codeword corresponds to the second set of DMRS ports; and
the second signaling indicates a first set of parameters associated with the first codeword and a second set of parameters associated with the second codeword.

10. The apparatus of claim 1, wherein:
the first set of DMRS ports excludes a mapping to a codeword;
the codeword corresponds to the second set of DMRS ports; and
the second signaling indicates a set of parameters associated with the codeword.

11. The apparatus of claim 1, wherein the second signaling further schedules the non-coherent joint transmission using a third set of DMRS ports associated with a second TCI state of the two or more TCI states.

12. (canceled)

13. (canceled)

14. (canceled)

15. An apparatus for wireless communication at a user equipment (UE), comprising:
a processor;
memory coupled with the processor; and
instructions stored in the memory and executable by the processor to cause the apparatus to:
receive first signaling indicating a plurality of transmission configuration indicator (TCI) states for a non-coherent joint transmission from a plurality of transmission-reception points, the non-coherent joint transmission comprising at least a first portion including first information common to a plurality of UEs comprising the UE and a second portion including information specific to the UE;
receive second signaling that schedules the non-coherent joint transmission using a first set of demodulation reference signal (DMRS) ports associated with a first TCI state, a second set of DMRS ports associated with a second TCI state, a third set of DMRS ports associated with the first TCI state, and a fourth set of DMRS ports associated with the second TCI state, wherein the first set of DMRS ports and the second set of DMRS ports correspond to the first portion of the non-coherent joint transmission and the third set of DMRS ports correspond to the second portion of the non-coherent joint transmission; and
receive the non-coherent joint transmission in accordance with the first TCI state.

16. The apparatus of claim 15, wherein the instructions are further executable by the processor to cause the apparatus to:
transmit a capability message indicating a capability of the UE to receive the non-coherent joint transmission using the first set of DMRS ports, the second set of DMRS ports, the third set of DMRS ports, and the fourth set of DMRS ports, wherein the non-coherent joint transmission is scheduled using the first set of DMRS ports, the second set of DMRS ports, the third set of DMRS ports, and the fourth set of DMRS ports based at least in part on the capability of the UE.

17. The apparatus of claim 16, wherein the capability message indicates a capability of the UE to support one or more codeword mapping schemes for the first set of DMRS ports, the second set of DMRS ports, the third set of DMRS ports, the fourth set of DMRS ports, or any combination thereof.

18. The apparatus of claim 15, wherein the instructions are further executable by the processor to cause the apparatus to:
determine the first set of DMRS ports, the second set of DMRS ports, the third set of DMRS ports, and the fourth set of DMRS ports based at least in part on one or more code division multiplexing groups and in accordance with a mapping between the first set of DMRS ports and the one or more code division multiplexing groups, the second set of DMRS ports and the one or more code division multiplexing groups, the third set of DMRS ports and the one or more code division multiplexing groups, and the fourth set of DMRS ports and the one or more code division multiplexing groups.

19. (canceled)

20. (canceled)

21. (canceled)

22. The apparatus of claim 15, wherein one or more fields of the second signaling indicate the first set of DMRS ports, the second set of DMRS ports, the third set of DMRS ports, and the fourth set of DMRS ports.

23. The apparatus of claim 15, wherein the instructions are further executable by the processor to cause the apparatus to:
determine the first set of DMRS ports, the second set of DMRS ports, the third set of DMRS ports, and the fourth set of DMRS ports based at least in part on the second signaling indicating a respective quantity of DMRS ports in each of the first set of DMRS ports, the second set of DMRS ports, the third set of DMRS ports, and the fourth set of DMRS ports.

24. The apparatus of claim 15, wherein:
a single codeword corresponds to the first set of DMRS ports, the second set of DMRS ports, the third set of DMRS ports, and the fourth set of DMRS ports; and
the second signaling indicates one or more parameters associated with the single codeword.

25. The apparatus of claim 15, wherein:
a first codeword corresponds to the first set of DMRS ports and the second set of DMRS ports;
a second codeword corresponding to the third set of DMRS ports and the fourth set of DMRS ports based at least in part on a mapping of a set of DMRS ports to a respective codeword corresponding to a respective portion of the non-coherent joint transmission; and
the second signaling indicates a first set of parameters associated with the first codeword and a second set of parameters associated with the second codeword.

26. (canceled)

27. (canceled)

28. (canceled)

29. An apparatus for wireless communication at a transmission-reception point (TRP), comprising:
a processor;
memory coupled with the processor; and
instructions stored in the memory and executable by the processor to cause the apparatus to:
transmit first signaling indicating a plurality of transmission configuration indicator (TCI) states for a non-coherent joint transmission from a plurality of TRPs comprising the TRP;
transmit second signaling that schedules the non-coherent joint transmission using a first set of demodulation reference signal (DMRS) ports and a second set of DMRS ports, the first set of DMRS ports being associated with two or more TCI states of the plurality of TCI states and the second set of DMRS ports being associated with a first TCI state of the two or more TCI states; and
transmit the non-coherent joint transmission in accordance with the two or more TCI states.

30. (canceled)
